(19) United States
(12) Patent Application Publication
(10) Pub. No.: US 2014/0180798 A1
(43) Pub. Date: Jun. 26, 2014

(54) CONTEXTUAL SELECTION AND DISPLAY OF INFORMATION

(71) Applicant: RichRelevance, Inc., (US)

(72) Inventors: Jacob Daniel Bailey, Orinda, CA (US); David Lee Selinger, Castro Valley, CA (US)

(73) Assignee: RICHRELEVANCE, INC., San Francisco, CA (US)

(21) Appl. No.: 13/727,372

(22) Filed: Dec. 26, 2012

(51) Int. Cl. G06Q 30/02

(52) U.S. Cl. CPC G06Q 30/0277
USPC 705/14.45; 705/14.73

(57) ABSTRACT

Techniques are described related to automatically selecting and providing contextually appropriate information, such as in some situations by providing restricted commerce-related information and associated functionality to authorized users via corresponding Web pages of an online retailer or other online commerce site. The selecting and providing of contextually appropriate information is performed in at least some situations in an automated manner by a computer-implemented contextual information selection service of a first entity on behalf of one or more target online retailer sites or other target online commerce sites of one or more other second entities, with the selection service further determining particular promotional materials to display or otherwise present to particular customers of those target online commerce sites in at least some embodiments. The provided restricted access information and associated functionality may be of various types, including merchandising-related information, placement information and/or social information.

### TECHNICAL FIELD

The following disclosure relates generally to providing information in a contextual manner, such as by providing authorized users with restricted commerce-related information and associated functionality via corresponding Web pages of an online retailer or other online commerce site.

### BACKGROUND

In addition to providing access to information, the World Wide Web (also referred to as the “Web”) has increasingly become a medium that is used to search for, shop for and order items (such as products, services and/or information) that are available for purchase, rent, lease, license, trade, evaluation, sampling, subscription to, etc. In many circumstances, a user may visit the Web site of an online retailer or other online commerce site that provides one or more items (sometimes referred to as a “Web store”), such as to view information about the items, give an instruction to place an order for one or more items, and provide information needed to complete the purchase (e.g., payment and shipping information). After receiving an order for one or more items, the online commerce site then fulfills the order by providing the ordered items to the indicated recipient, such as by delivering product items electronically (e.g., music downloaded over the Internet) and/or through physical distribution channels (e.g., shipment via a governmental postal service or private common carrier, such as for paperback books). Similarly, some service items may be provided electronically (e.g., providing email service), while others may be provided physically (e.g., performing cleaning services at the purchaser's house).

While access to information about items via the Web provides many benefits, various problems also exist. As one example, given the large numbers of items that may be available from an online commerce site, it can be difficult for the online commerce site to provide information about particular products or other commerce items to consumer users in appropriate situations.

### BRIEF DESCRIPTION OF THE DRAWINGS

FIG. 1 is a network diagram illustrating an embodiment of a contextual information selection service for dynamically selecting and providing appropriate information in a contextual manner.

FIGS. 2A-2J illustrate examples of dynamically selecting and providing appropriate information in a contextual manner in particular situations.

FIG. 3 is a block diagram illustrating example computing systems suitable for executing a contextual information selection system for performing techniques related to dynamically selecting and providing appropriate information in a contextual manner.

FIG. 4 is a flow chart of an example embodiment of a Contextual Information Selection Service routine.

FIG. 5 is a flow chart of an example embodiment of a Selection Manager routine.

FIG. 6 is a flow chart of an example embodiment of an Authorized User Interaction Manager routine.

FIG. 7 is a flow chart of an example embodiment of a User Computing Device routine.

### DETAILED DESCRIPTION

Techniques are described related to automatically selecting and providing contextually appropriate information in various manners, such as in at least some embodiments by providing restricted commerce-related information and associated functionality to authorized users via corresponding Web pages of an online retailer or other online commerce site. In some embodiments, the selecting and providing of contextually appropriate information is performed in an automated manner by a computer-implemented Contextual Information Selection (“CIS”) Service of a first entity on behalf of one or more target online retailer sites or other target online commerce sites of one or more other second entities (e.g., for target online commerce sites that are clients of the CIS Service), with the CIS Service further determining particular promotional materials to display or otherwise present to particular customers of those target online commerce sites in at least some embodiments. In other embodiments, such a CIS Service may instead be integrated with or otherwise operate with a single target online commerce site.

The selecting and providing of the contextually appropriate information may occur in various manners, including in some embodiments to reflect information displayed on particular Web pages or other information pages of online retailer Web sites or other electronic commerce sites that use the functionality of the CIS Service. For example, if a particular Web page of a particular online retailer (e.g., a Web page that includes information about one or more particular retail items available from the online retailer) is displayed to an appropriate user, contextually appropriate information may be selected and provided that corresponds to the subject matter and other context of that Web page (e.g., by providing additional information as part of that Web page that is related to business operations of the online retailer corresponding to those one or more retail items). By enabling such an authorized user to access contextually appropriate information and related functionality from particular locations of an online commerce Web site or other target electronic site, the user may, for example, be enabled to more efficiently access and control desired information, as is discussed in greater detail below.

As noted above, the contextually appropriate information that is selected and provided via a target electronic site may in some embodiments be restricted access information (e.g., confidential or otherwise protected information) whose availability is restricted to one or more authorized users. For example, if the target electronic site is a Web site of an online retailer, restricted access information and associated functionality may be provided on a version of some or all Web pages of that Web site to authorized users who are affiliated with the online retailer, such as employees of the online retailer, while other non-authorized users (e.g., customers of the online retailer) would receive Web pages that do not include the restricted access information and associated functionality. In addition, in some embodiments the authorized users who are able to receive at least some types of restricted access information via such a target online retailer Web site may include one or more other types of users, whether instead of or in addition to authorized users who are affiliated with the online retailer, including from the following non-exclusive list: users who are employees of or otherwise represent the CIS Service; users who are employees of or otherwise represent third-party entities that interact with or are otherwise affiliated with a target online commerce site (e.g., a product manufacturer or brand manager or other advertiser, or an agent acting on behalf of such an advertiser, that provides advertising to customers via the target online commerce site, a distributor or wholesaler or other supplier of items to the target online commerce site, a business customer for which the target online commerce site is part of its supply chain, etc.); etc. In a similar manner, authorized users may be enabled to receive at least some types of restricted access information via a target online commerce site that is not operated by an online retailer, including for authorized users who are employees of or otherwise represent other types of such target online commerce sites—such target online commerce sites may include, for example, an online travel commerce site, an online automotive commerce site, an online commerce site of a financial organization, an online commerce site that provides access to digital content, etc.

In addition, the restricted access information that is selected and provided for a particular authorized user may be specific to that user, such as to include information that is automatically determined to be of interest to that user or otherwise relevant for that user, and/or to exclude information that is automatically determined to not be of interest to that user or otherwise to be irrelevant for that user (e.g., to exclude a subset of the restricted access information that the user is not authorized to receive). As one example, an authorized user who is an employee of an online retailer and assigned a particular role for the online retailer may receive access to confidential information about business operations of the online retailer that correspond to that role, but may not receive access to other confidential information about the business operations of the online retailer that do not correspond to that role, or to confidential information about third-party entities affiliated with the online retailer (e.g., advertisers who provide promotional materials to customers of the online retailer via the Web site of the online retailer). As another example, an authorized user who is an employee of or otherwise represents a third-party advertiser that performs advertising via one or more online retailers may receive access to confidential information about performance of the advertising for that advertiser via the Web sites of the online retailer(s), but may not receive access to confidential information about the business operations of the online retailer(s), or to confidential information about other distinct third-party entities. Conversely, at least some authorized users (e.g., users who are employees of or otherwise represent the CIS Service) may receive access to any confidential information available to the CIS Service, including information about business operations of online retailers and about performance of advertising for advertisers. Furthermore, an authorized user may in some embodiments and situations be enabled to select a particular subset of available restricted access information that is of interest to the authorized user, whether in addition to or instead of having information that is automatically determined to be relevant and/or not relevant for the authorized user, and with the restricted access information that is provided to the authorized user including at least some of that selected subset of information.

Furthermore, the restricted access information that is selected and provided via a particular target online commerce site may include various types of information in various embodiments and situations, including commerce-related information corresponding to commerce activities that take place at the target online commerce site. A first type of restricted access information that may be provided for a particular target online commerce site in some embodiments and situations includes merchandising analytics information corresponding to sales of products and other retail items via the target online commerce site, and/or to other types of merchandising-related activities that occur at the target online commerce site or that are performed by user representatives of the target online commerce site. A second type of restricted access information that may be provided for a particular target online commerce site in some embodiments and situations includes placement information corresponding to various types of advertising, recommendations and/or promotions that occur via the target online commerce site. A third type of restricted access information that may be provided for a particular target online commerce site in some embodiments and situations includes social information corresponding to activities of other specified users, such as other authorized users associated with the target online commerce site who perform activities that include interactions with one or more types of business data for the target online commerce site.

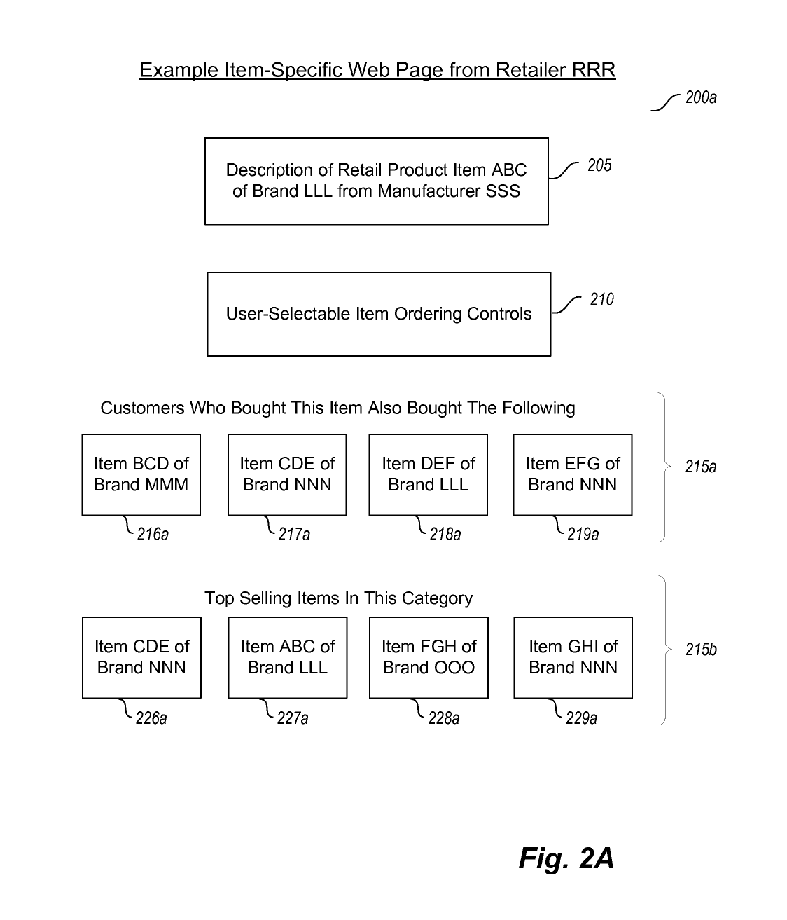

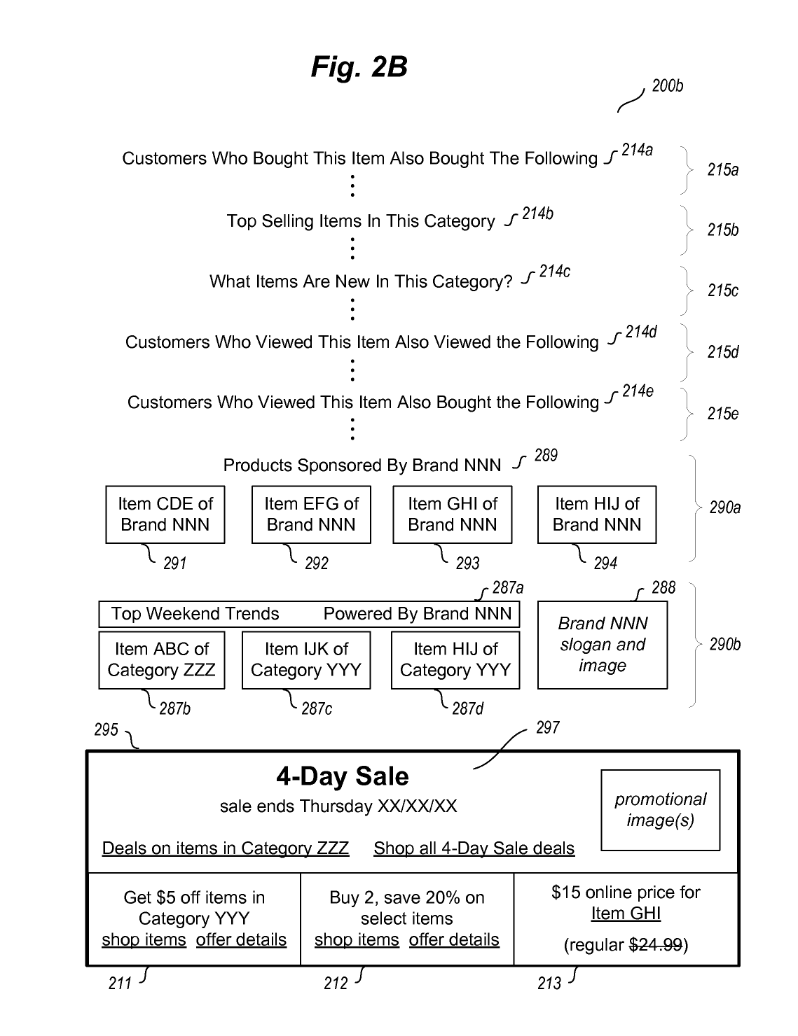

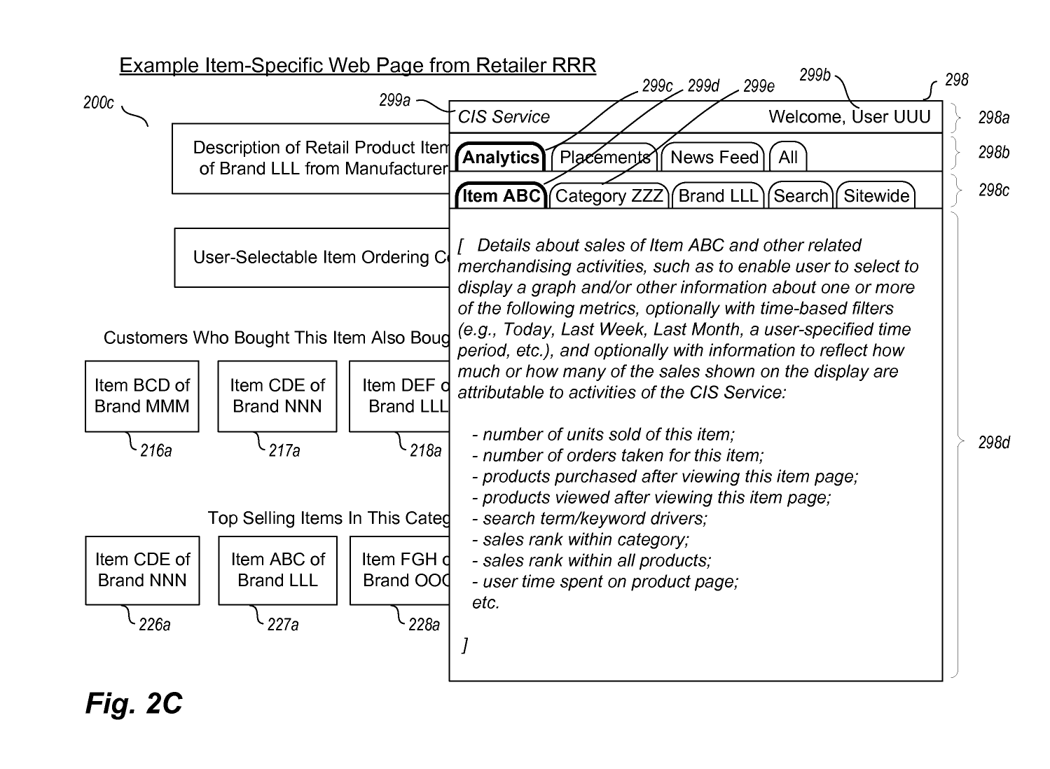

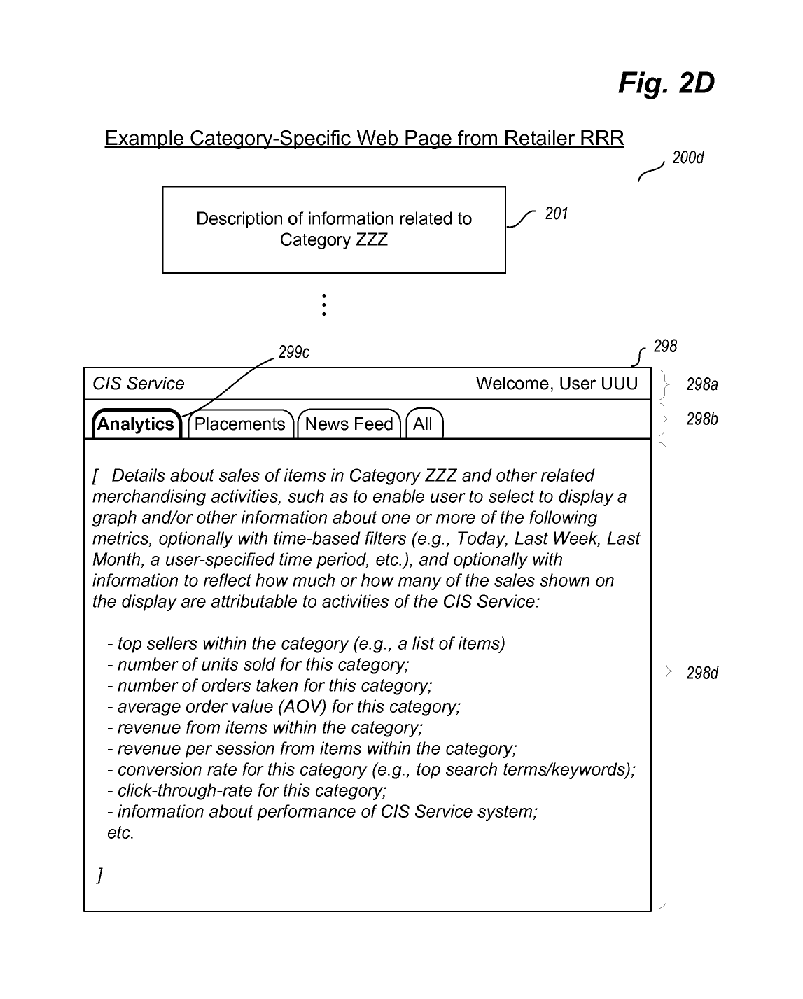

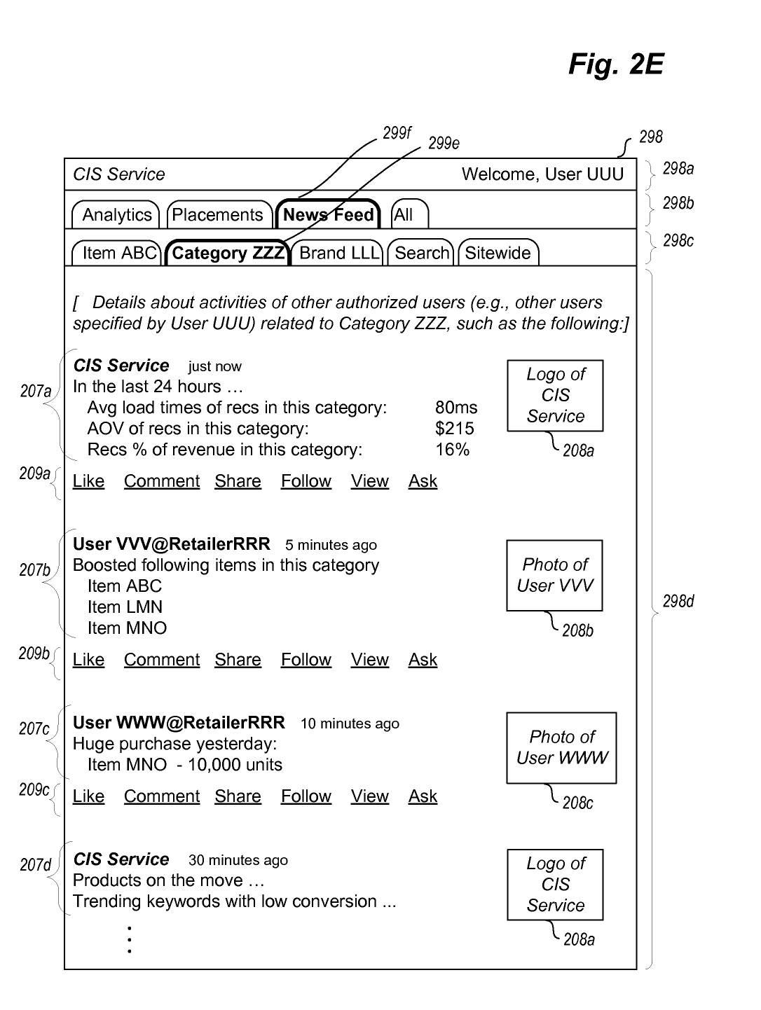

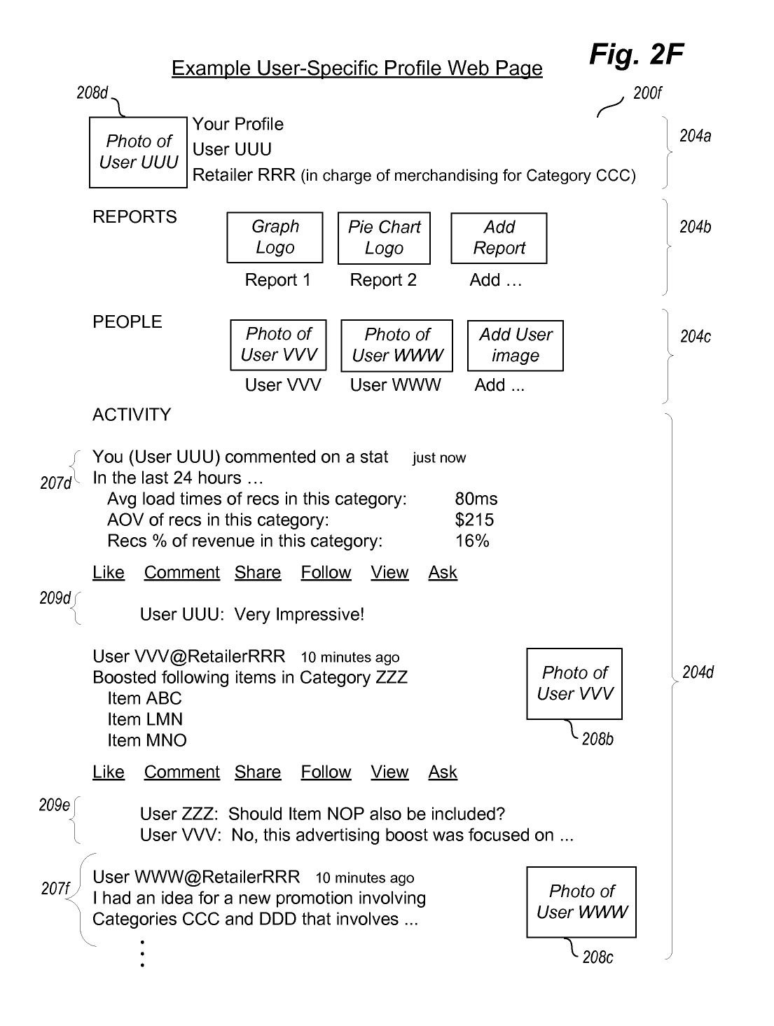

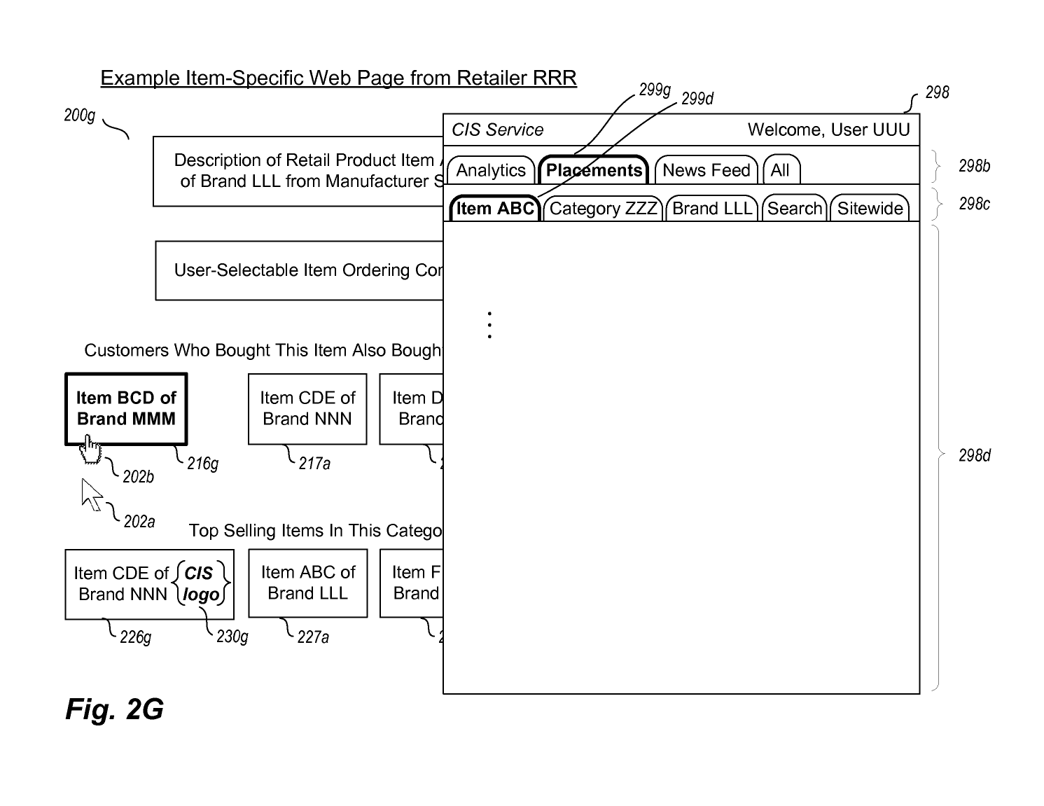

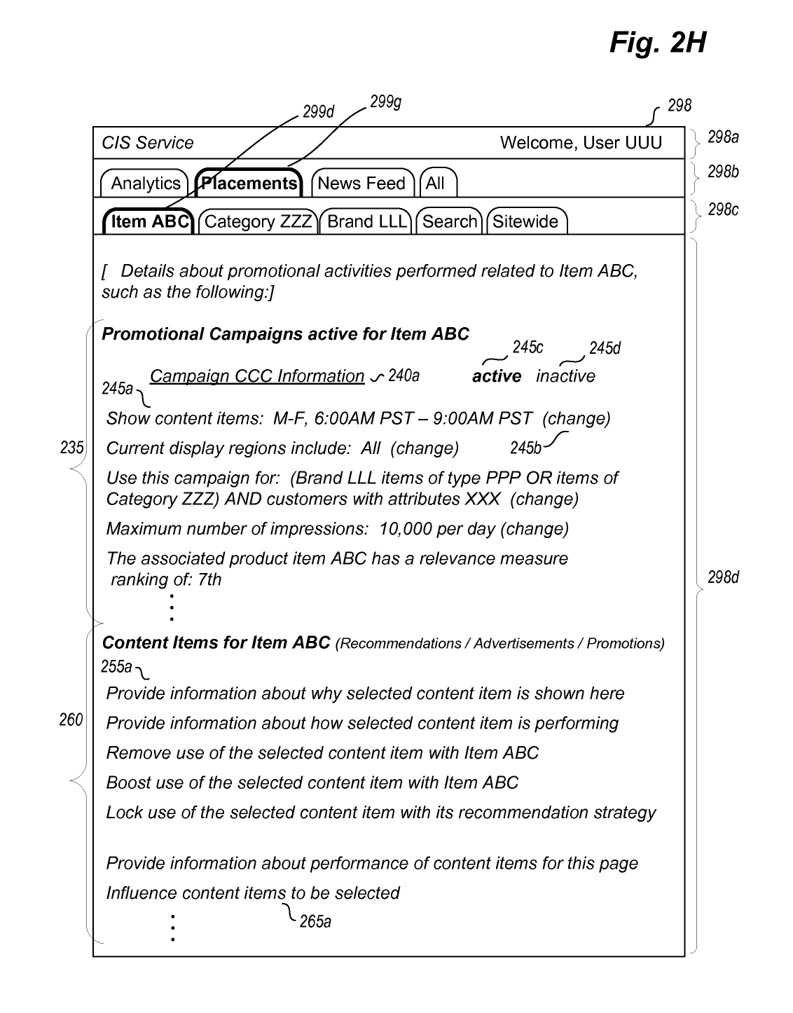

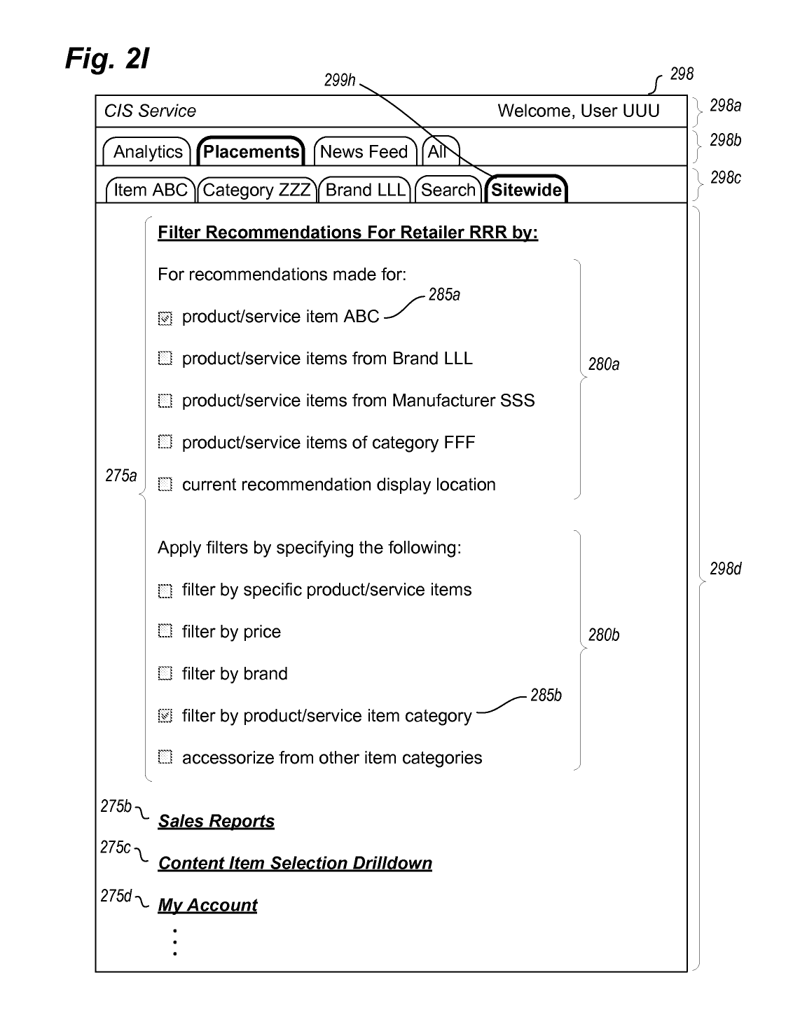

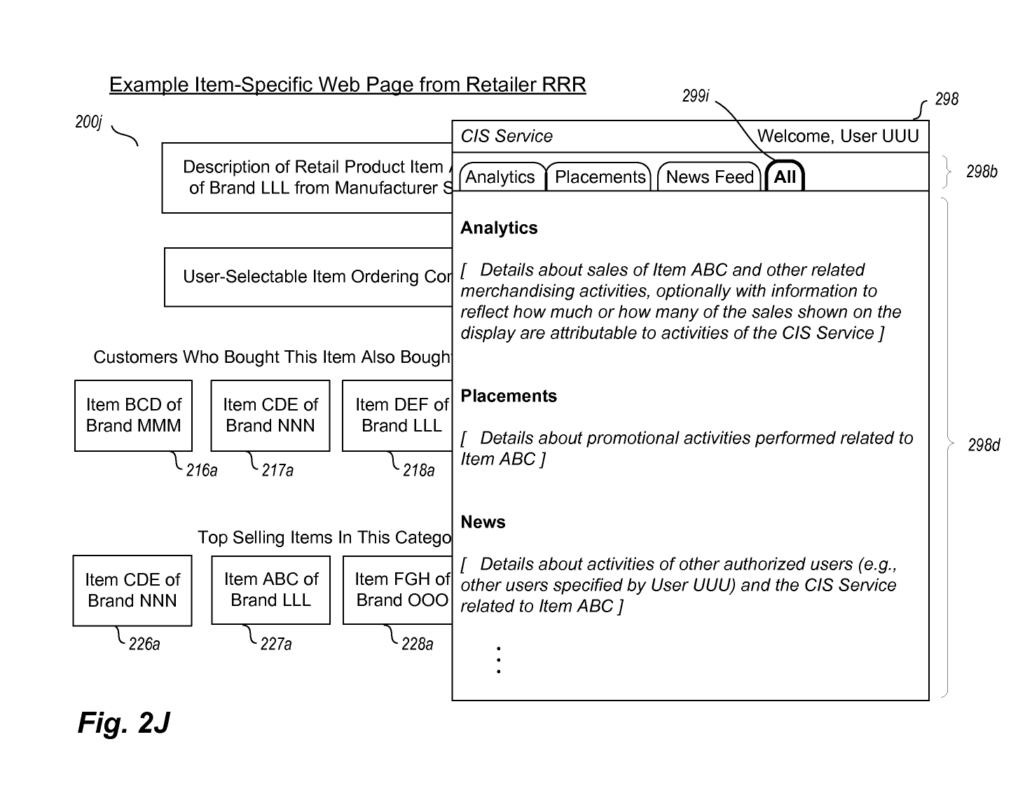

In addition, restricted access information that is provided may in some situations and embodiments include information about prior activities that have already occurred and/or activities that are occurring in real-time or near-real-time (e.g., in a preceding period of time that includes a small number of seconds, minutes and/or hours), such as performance information about effectiveness of particular placements, and/or merchandising information about particular commerce-related activities of customers (e.g., items that are viewed, purchased, or otherwise selected; search keywords (or “terms”) that are used in other commerce-related activities, such as to identify items to purchase; etc.). Furthermore, restricted access information that is provided may in some situations and embodiments include user-selectable controls via which an authorized user may control or otherwise influence future activities that occur for the target online commerce sites (e.g., further placement activities) and/or may control or otherwise influence which restricted access information is provided to the authorized user currently or in the future. FIGS. 2A-2J illustrate examples of particular types of restricted access information and related functionality that may be provided in particular example situations.

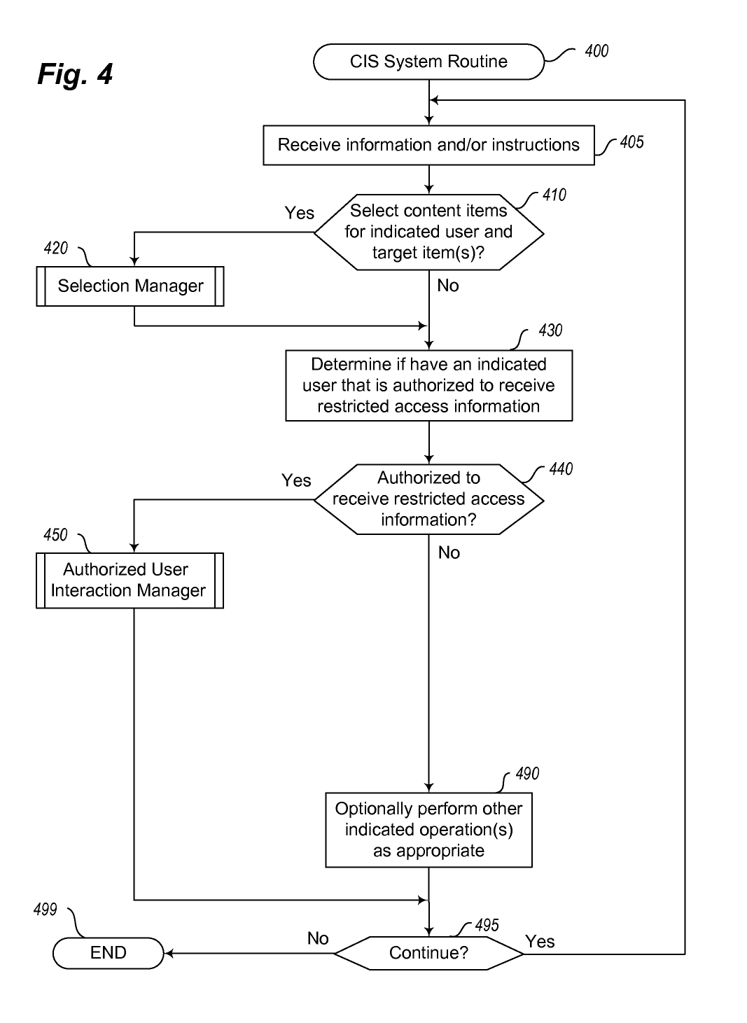

FIG. 2A illustrates an example of an item-specific Web page 200a that is provided by an example online retailer RRR, such as for display to a particular user (not shown), and FIGS. 2B-2J illustrate examples of possible modifications to the Web page 200a in conjunction with the described techniques, including to provide additional restricted access information and functionality to an authorized user. The flowcharts of FIGS. 4-7 illustrate additional details regarding some example embodiments of providing and using information to users.

For illustrative purposes, some embodiments are described below in which specific types of restricted access information to enable specific types of user analysis and control are provided to specific types of users in specific types of manners. These examples are provided for illustrative purposes and are simplified for the sake of brevity, and the inventive techniques may be used in a wide variety of other situations, some of which are discussed below, with the techniques not being limited to use with particular types of products or more generally with particular types of items, to particular types of user interfaces or other mechanisms for interacting with users, etc. For example, in some embodiments, the described techniques may be used to select entities (e.g., people, businesses or other organizations, etc.) or other things distinct from retail items, etc. Thus, the described techniques may be used in a variety of situations and to provide a variety of benefits.

With respect to FIG. 2A, the example Web page 200a is specific to a particular example product item ABC that is associated with an example brand LLL from an example manufacturer SSS, and is provided to a user (not shown) for display. The example Web page 200a includes various information 205 about the example product item ABC, and various user-selectable item ordering controls 210 with which a customer user may interact to initiate the purchase or other acquisition of product item ABC from an online retailer RRR that provides the Web page 200a. In this example, the Web page 200a also includes sections 215a and 215b that have information about various placement information selected for display along with the information 205 and 210 about item ABC. In this example, the placement information includes targeted product recommendations based at least in part on the current product item ABC, such as for potential selection and purchase by the user. For example, the product recommendations section 215a in this example corresponds to other items that are related to the current item based on prior purchase actions of customer users who purchased both the current item and the recommended other items, and includes four example content items 216a-219a that are recommendations for four such other items. In addition, the product recommendations section 215b in this example corresponds to top-selling items in the same product category of the current item, and includes four content items 226a-229a that are recommendations for four such other items. For example, the four such other items with which the four content items 226a-229a are associated may be a first group of the four highest top-seller items in the category. The product recommendations from sections 215a and/or 215b may be obtained in various manners in various embodiments, such as to be determined by the online retailer RRR and/or supplied by an embodiment of the CIS Service (not shown), optionally in conjunction with one or more external product recommendation services. In addition, various other types of placement information may be selected and used in other situations, as discussed in greater detail with respect to FIG. 2B and elsewhere.

FIG. 2B illustrates a variety of types of information 200b that may be included with a Web page such as Web page 200a of FIG. 2A, whether instead of or in addition to placement information 215a and 215b of FIG. 2A. In particular, as mentioned with respect to FIG. 2A and elsewhere, the CIS Service may in some embodiments provide functionality to select and/or provide various types of placement content items for display on some or all Web pages of one or more online retailers or other types of target online commerce sites. In this illustrated example, the placement information that may be selected and/or provided includes various types of product recommendations 215, advertisements 290, and/or promotions 295. In particular, FIG. 2B illustrates that product recommendations may include recommendations 215a and 215b in a manner similar to that illustrated with respect to FIG. 2A, but without some details about particular product recommendations being shown in FIG. 2B. In addition, each of the product recommendations 215a and 215b correspond to a different type of recommendation strategy in this example, with the product recommendations 215a being based on a recommendation strategy 214a related to similarity between product items based on customers who bought a particular first item also buying other particular second items. The recommendation strategy 214b for product recommendations 215b reflects popularity of particular product items in a given product category, and in particular corresponds to the top selling items in that category. A non-exclusive list of other types of recommendation strategies include 214c-214e illustrated with respect to possible product recommendations 215c-215e, respectively, such as to recommend items that are newly introduced to a particular category, to identify related items based on customers who viewed a particular first item also having viewed other related second items, and to identify related items based on customers who viewed a particular first item also having bought other related second items. As discussed in greater detail elsewhere, a variety of other types of recommendation strategies may be used in other situations, including to combine or otherwise use two or more recommendation strategies with respect to a single Web page or other information page in some embodiments and situations, while in other embodiments and situations a single recommendation strategy that is best or otherwise preferred for a given situation may be selected and used (e.g., with a different other recommendation strategy being selected as being best or otherwise preferred for a different second situation).

In addition to the product recommendations 215 illustrated in FIG. 2B, various types of placement advertisement content items 290 may also be selected and/or provided in particular situations, whether instead of or in addition to product recommendation content items. In the illustrated example of FIG. 2B, multiple types of advertisements 290 are illustrated, with a first group of advertisements 290a being shown that include content items 291-294 corresponding to particular retail items being displayed together with information 289 indicating that the display of those retail items is sponsored by a particular brand. It will be appreciated that other types of entities may similarly be such a sponsor in other situations, such as item manufacturers, item suppliers, etc. Advertisements 290b illustrate other types of advertisement content items that may be used, such as an area 288 having a visual representation in this example that includes information about a particular brand with a corresponding slogan and image, and optionally being user-selectable such that a user selection of the area 288 will cause additional information to be displayed to the user related to the subject of the advertisement content item. It will be appreciated that such advertisements may have various types of associated content (e.g., video, sounds, etc.) and may be associated with various types of entities (e.g., a particular item, a group of related items, a brand, a company, etc.). In addition, example information 287 illustrates another group of displayed content items 287b-287d corresponding to particular retail items and that may be displayed together as a group—in this example, the group corresponds to retail items that are popular trends for weekend activities, with the presentation of the group being indicated 287a as being powered by a particular brand. As discussed in greater detail elsewhere, a variety of other types of advertisement techniques may be used to present a variety of types of advertisement content items.

FIG. 2B further illustrates various placement promotion content item information 295, which in this example corresponds to a promotional campaign or other promotions that may be initiated by a particular online retailer, such as for display on Web pages provided by that online retailer. In this example, the promotional content items include information 297 that illustrates an example four-day sale with particular items being part of the sale and with user-selectable controls provided to enable a user to select and obtain additional information about the items for the sale (e.g., by including user-selectable links within the information 297, as illustrated in this example using underlining). In addition, the example promotional content items 295 include other information 211, 212 and 213 corresponding to particular sales or promotions being provided at the current time, again with user-selectable controls that a user may use to obtain additional corresponding information. As with the illustrated examples of retail item recommendation content items and advertisement content items, the promotional content items may have various forms and be displayed in various manners in various embodiments. For example, while not illustrated here, in some embodiments placement information may include multiple content items of multiple types that are to be displayed together in a specified integrated manner using an aggregation form displayed on a portion of a Web page, such as to include multiple content items that are related in a common theme (e.g., associated with the same brand)—such as aggregation form may include, for example, a logo, a GUI skin for some or all of the aggregation form, a user-selectable video related to the brand, an image related to a manufacturer or other entity associated with the brand, and additional details about one or more particular items of the brand.

FIG. 2C continues the example of FIG. 2A, but with the modified Web page 200c of FIG. 2C including additional restricted access information that is displayed as part of the Web page, based on the current user being determined to be authorized to receive the additional restricted access information. In particular, in this example, a variety of additional information 298 is displayed on the right side of the Web page, and in a manner that overlaps with and overlays other information that was previously illustrated with respect to Web page 200a of FIG. 2A. Such a display of additional information may be initiated or controlled in various manners in various embodiments, as discussed in greater detail below, including based on JavaScript that is included with the Web page and that initiates the display under specified criteria (e.g., the current user being determined to be authorized). It will be appreciated that the details of the display of the information 298 are provided for illustrative purposes only, and that in other embodiments such additional restricted access information may be displayed in other manners, such as in other locations of the Web page, without overlapping and/or overlaying other information of the Web page, in a separate frame or other display portion of the Web page, in a separate pop-up window or other separate display area that is associated with but not part of the Web page, being initiated or controlled in a manner other than using JavaScript (e.g., via HTLM5, cascading style sheets, Adobe Flash, Ajax, Dynamic HTML, by dynamically modifying the content of the Web page, etc.), etc. In addition, it will be appreciated that various user-selectable controls may be provided to enable the user to modify how and/or where such restricted access information is displayed. Similarly, the particular types of restricted access information that are displayed are simplified for the sake of understanding, and that other types of restricted access information may be displayed in other embodiments.

In this example, the restricted access information 298 includes header information 298a that identifies the current user (in this example referred to as “User UUU”) and that includes an indication of the CIS Service, which is providing the additional restricted access information for use by the current user. As discussed in greater detail elsewhere, the current user may be identified as being authorized in various manners, including concurrent or prior login activities, based on information associated with the client computing device in user by the user (e.g., identifying information about the device and/or its location, such as an IP address or a MAC address; identifying information previously stored on the device, such as a browser cookie; etc.).

The illustrated example restricted access information 298 of FIG. 2C further includes two groups 298b and 298c of user-selectable controls that enable the user to specify particular types of contextually appropriate information to display based at least in part on contents and subject matter of the current Web page 200c, although in other embodiments one or both of the sets of controls 298b and 298c may not be displayed (e.g., if the CIS Service selects and provides restricted access information that is automatically determined to be contextually appropriate for the current situation), and/or additional types of user-selectable controls may be provided. In the illustrated example, the first row 298b of user-selectable controls correspond to types of restricted access information that are available, while the second row 298C of user-selectable controls correspond to a level or degree of specificity of that type of restricted access information. The group of user-selectable controls 298c in the second row may in some embodiments be based on the current selection in the first row of controls 298b.

In this example, the Analytics information tab 299c is currently selected in the first row 298b, with other options corresponding to Placements information, News Feed social information, and All information. The group of user-selectable controls 298c in the second row in this example includes a currently selected tab 299d that reflects the current retail item (Item ABC) for which information is currently being displayed in the Web page 200c. Accordingly, the information displayed below in the section 298d of the restricted access information will provide analytics-related information corresponding to Item ABC, based on the selections 299c and 299d. If the user instead changed the selection in the second group 298c from the Item ABC tab 299d to Category ZZZ tab 299e, for example, the information in section 298d would be updated to reflect analytics-related information corresponding to that category, of which Item ABC is a part—FIG. 2D illustrates additional category-related information for a different Web page having a different context. Other options in the current example second row of controls 298c include a tab for Brand LLL (to which Item ABC belongs), a Search tab to enable search-related information to be accessed, and a Sitewide tab to enable information related to the entire Web site of Retailer RRR to be displayed. It will be appreciated that other types of user-selectable controls may be provided in other manners in other embodiments, including to display types of hierarchical categorization of information other than by category or brand in non-retail environments.

As noted above, the information initially displayed in section 298d of the restricted access information 298 includes analytics-related information for retail product Item ABC in the illustrated example of FIG. 2C. Such analytics-related information related to Item ABC may be of various types and of various forms, such as to include information about one or more of a quantity of units of Item ABC that have been sold, about a quantity of orders taken for Item ABC, about other products purchased after viewing this Web page for Item ABC, about other products viewed after viewing this Web page for Item ABC, about search keywords used by consumers that led to views of this Web page for Item ABC and/or to purchases of Item ABC, about the sales rank of Item ABC within its category and/or within all products, about the amount of time that consumer users spend viewing or otherwise interacting with this Web page for Item ABC, etc. Furthermore, while not illustrated here, the information included in section 298d may further include additional user-selectable controls related to the display of the analytics-related information, such as to enable the user to select particular time periods (e.g., Today, Last Week, Last Month, etc.) or other filters or criteria corresponding to the information to be displayed, to control particular types of analytics-related information that is included, etc.

It will be appreciated that a variety of other types of analytics-information may be displayed for a retail item or other type of target item in other embodiments, and that various user-selectable controls may be displayed to enable the user to further control the display of restricted access information, including to request and receive additional restricted access information that is not initially displayed. A non-exclusive list of types of statistics that may be made available via the restricted access information to the authorized user related to the current retail item include the following: trailing conversion graphs; overall sales rank; category sales rank; brand rank against others; product rank within brand; recommendation click-through rate; sales history graph; margin statistics; number of times recommended per day; top keywords leading to sale; price changes over time; time spent by product and/or brand; glass view metrics; bounce rates by brand; shopping cart abandonment rates by brand; products and/or brands in each category with lowest number of return-visit purchases; information about sharing of the product by other users; etc. Trailing conversion graphs may, for example, for a given product, display item conversion rates (number of views divided by purchases) on a retailer's site, such as for a specified prior and/or current time period. Overall sales rank may, for example, for a given product on a retailer's site, indicate the sales rank of that particular product versus the rest of the products sold on that site, such as for a specified prior and/or current time period. Category sales rank may, for example, for a given product in a particular product category on a retailer's site, indicate the sales rank of that particular product versus the rest of the products in that product category that are sold on that site, such as for a specified prior and/or current time period. Brand rank against others may, for example, for products on a retailer's site having a particular brand, indicate the sales rank of that brand's products versus products of other brand that are sold on that site, such as for a specified prior and/or current time period. Product rank within brand may, for example, for a given product on a retailer's site having a particular brand, indicate the sales rank of that particular product versus the rest of the products of that brand that are sold on that site, such as for a specified prior and/or current time period. Recommendation click-through rate may, for example, indicate, for a product recommended to consumers (e.g., regardless of the medium via which the recommendations occurs), what is the average percentage of times that the consumers click on (or otherwise select) that product, such as for a specific prior and/or current volume of recommendation impressions. Sales history graph may, for example, for a given product, brand, category, or website, provide a visual representation (e.g., a graph) of respective sales, such as for a specified prior and/or current time period. Margin statistics may, for example, for a given product on a retailer site, indicate the gross profit margin for the product, such as for a specified prior and/or current time period. Number of times recommended per day may, for example, for a given product, indicate the number of times that the product has shown up as a recommendation (e.g., an amount of recommendation impressions), such as for a specified prior and/or current time period. Top keywords leading to a sale may, for example, for a given product or brand, indicate the consumer search terms or keywords (e.g., as used on a retail site) that most often lead to a sale of that product or for that brand, such as for a prior and/or current specified period of time. Price changes over time may, for example, indicate a graphical or numerical (e.g., percentage) representation of a product's retail price and how it has changed over time, such as for a prior and/or current specified period of time. Time spent by product and/or brand may, for example, for a given product or a given brand (with the brand being represented by all products in that brand), indicated the amount of time that consumers spend looking at one or more corresponding product page(s) (e.g., before navigating to another page), such as for a prior and/or current specified period of time. Glass view metrics may, for example, for a given product, advertisement, or promotion, indicate the number of times that a consumer is actually able to view the item being represented (e.g., the consumer scrolls their Web browser window over a certain location on a Web page of a retailer's site where the item is displayed), such as for a prior and/or current specified period of time. Bounce rate by brand may, for example, for a given brand (with the brand represented by all products in the brand), indicate a rate at which consumers who view a corresponding product or brand page actually proceed to buy a product of the brand, such as for a prior and/or current specified period of time. Product or brand abandonment rate may, for example, for a given product or brand (with the brand represented by all products in the brand), indicate a rate that reflects the number of page abandonments divided by the total number of product page views for a corresponding product, such as for a prior and/or current specified period of time. Shopping cart abandonments may, for example, for a given product or brand (with the brand represented by all products in the brand), indicate a rate that reflects the number of shopping carts having a corresponding product that are abandoned divided by the total number of such shopping carts having a corresponding product, such as for a prior and/or current specified period of time. Return visit purchases may, for example, measure consumer return rates (whether consumers who purchase products or brands on a retailer's site return and purchase again) and rank them in order from least to greatest (or vice versa), given the purchase of a particular product, such as for a prior and/or current specified period of time.

In addition, in at least some embodiments, the CIS Service will also include information in the section 298d that corresponds to the effect or influence of activities of the CIS Service on the analytics-related information that is displayed, such as to indicate a total number of units of Item ABC that have been sold, and to indicate a percentage or other portion of those sold units that are caused by or influenced by activities of the CIS Service (e.g., based on content item placements that are displayed to particular users and are attributed to subsequent purchases of Item ABC by those users). Other types of information about the performance and activities of the CIS Service may similarly be provided in at least some embodiments, such as the average time that it takes the CIS Service to respond to a request for placement information for Web page 200c or for other Web pages (e.g., sitewide).

FIG. 2D continues the examples of FIGS. 2A-2C, and includes a different Web page 200d with different associated contextually appropriate restricted access information 298. In particular, in the example of FIG. 2D, the illustrated Web page 200d includes information related to a category of retail items (in this example referred to as Category ZZZ, to which Item ABC belongs), rather than information related to a particular retail item as illustrated for Web pages 200a and 200c. Correspondingly, the information that is included in the section 298d of the restricted access information for FIG. 2D initially defaults in this example to showing category-related information for this category, rather than item-related information as was shown in section 298d of FIG. 2C. In addition, the example of FIG. 2D further illustrates that the restricted access information 298 may be displayed in other locations, such as to be displayed near the bottom of Web page 200d in FIG. 2D rather than to the right of Web page 200c of FIG. 2C.

In the example of FIG. 2D, the restricted access information 298 includes header information 298a similar to that previously displayed, and similarly includes a first row of controls 298b, with the “Analytics” tab 299c currently being selected. However, in the illustrated example, the second row of controls 298c is not illustrated, such as if the CIS Service has automatically selected that category-related information of Category ZZZ is a contextually appropriate degree or level of information for the current Web page 200d (e.g., based on Web page 200d including category-related information), and displayed information in section 298d accordingly. In particular, in this example, the information in section 298d includes various analytics-related information about Category ZZZ, some of which may be similar types of information to that of FIG. 2C, but related to Category ZZZ rather than to Item ABC (e.g., a quantity of units sold for this category in FIG. 2D rather than a quantity of units sold for the item in FIG. 2C). In addition, some additional types of restricted access information may be appropriate for such category-related analytics information, such as to indicate top sellers within the category, average order value (“AOV”) for the category, etc. The analytics-related information that is displayed may include not only sales-information, but also information related to how the merchandising occurs, such as a conversion rate for this category that reflects how frequently users who use particular search keywords proceed to purchase relevant items from this category, or a click-through-rate for content items corresponding to this category that are displayed to users and subsequently selected by (e.g., clicked on) the users. It will be appreciated that a variety of other types of category-related information may be displayed in other embodiments, and that various user-selectable controls may be displayed to enable the user to further control the display of restricted access information, including to request and receive additional restricted access information that is not initially displayed.

While not illustrated here, similar types of restricted access information may be provided for other types of Web pages, including for the CIS Service to automatically select other types of contextually appropriate information to display for such other Web page types. As one example, some Web pages may not be associated with any particular item or category (e.g., a home page for the Web site), and if so, the CIS Service may automatically select or default to displaying sitewide information for Retailer RRR's Web site, such as in a manner similar to selection of the Sitewide tab in the second group of controls 298c—such types of sitewide information may include, for example, top selling products sitewide, sitewide shopping conversion information, top converting keywords sitewide, etc. As another example, some Web pages may be associated with other particular types of information or functionality (e.g., a search functionality for the Web site), and if so, the CIS Service may automatically select or default to displaying search-related information, such as in a manner similar to selection of the Search tab in the second group of controls 298c—such types of search-related information may include, for example, historical keyword conversion statistics, revenue per search for certain keywords (e.g., for top keywords and/or bottom keywords), top products recommended for certain keywords (e.g., for top keywords and/or bottom keywords), AOV per search, etc. In addition or alternatively, the authorized user could type in or otherwise specify a particular search keyword, and receive historical and/or real-time information about performance of that keyword at the Web site. A non-exclusive list of types of statistics that may be made available via the restricted access information to the authorized user related to search-related information include the following: keyword searches that lead to the lowest conversion in a current or specified category; keyword searches that most often lead to no results found; brands with the highest purchase acceleration over 30 days; reports on recently trending keywords; product naming differences between what customers search for versus what is ultimately purchased; etc.

While also not illustrated here, similar types of restricted access information may be provided for other types of aggregated retail item information, such as information corresponding to a particular brand or manufacturer. For example, use of the “Brand LLL” tab of the controls 298c of FIG. 2C may cause corresponding information to be displayed in section 298d of the restricted access information. Furthermore, as discussed in greater detail elsewhere, such types of brand-specific information or manufacturer-specific information may in some embodiments be available to authorized users only if they are representatives of or otherwise associated with that brand or manufacturer.

In addition, while the prior examples have focused on information corresponding to an online retailer, in other embodiments similar information may be provided for one or more physical stores, whether in addition to or instead of information about an online retailer. As one example, an online retailer may also have one or more physical stores, and the information provided via the restricted access information 298 may include such an online retailer to determine merchandising-related information for only the online sales, for only the physical sales from one or more particular locations (e.g., to determine near-real-time retail items whose sales are trending upward or downward at a particular physical store), or for a specified combination of online and physical sales. The information related to sales and other merchandising-related information for physical locations and/or online sales may be obtained in various manners in various embodiments, including by tracking online customer sales and other activities (e.g., customer searches, customer selection of retail items to view, customer selection of retail items to purchase, etc.), from a database or other electronic reporting by the retailer, from information based on customer use of loyalty cards or other affinity programs, from information from a CRM (Customer Relationship Management system or other similar software, from an employee tracking system (e.g., with social networking features), from an external social networking site and/or other site via which authorized users and/or customers interact, etc.

FIG. 2E continues the examples of FIGS. 2A-2D, and in particular provides an alternative version of restricted access information that may be displayed to a user, such as with respect to Web pages 200a, 200c and/or 200d. In particular, in the illustrated embodiment, the News Feed social information tab 299f is selected from the first row of controls 298b, and the Category ZZZ tab 299e of the second row of controls 298c is also selected, resulting in the information included in section 298d being social information about activities of selected entities corresponding to Category ZZZ. The tabs 299f and/or 299e may be selected in various manners in various embodiments and situations, such as to be initially selected defaults that are automatically determined by the CIS Service as being contextually appropriate for a given situation, or instead may be selected by a user after other information was initially displayed to the user. In this example, the News Feed social information tab 299f provides information about activities of particular other authorized users, such as other users that the current user has previously selected and/or that are otherwise associated with the current user (e.g., users in the same group, users in the same role, users that the current user supervises or is supervised by in a hierarchical organization of the online retailer or other organization, etc.). In addition, in the illustrated embodiment, some of the news feed information may include information about activities about the CIS Service with respect to the Web site of the current online retailer. In the illustrated example, various of the information and controls in section 298d are illustrated in a manner similar to that of social networking site information, but it will be appreciated that similar types of information may be provided in other manners in other embodiments.

In the illustrated example, the News Feed social information in section 298d includes particular groups of information 207 that are relevant for the current user and/or the current Web page (not shown) with which the information is displayed, with each group 207 including associated user-selectable controls 209 to provide additional restricted access functionality and/or information to the current user. For example, the group of information 207a corresponds to activities that have just been performed by the CIS Service, and in particular include statistics that have just been generated for the last 24 hours corresponding to performance for the currently selected Category ZZZ. It will be appreciated that if a different tab was selected in the row 298c, such as for product Item ABC, the group of information 207a may instead reflect similar statistics corresponding to the specified item, or instead may not be displayed if the group of information 207a is determined by the CIS Service to not be relevant with respect to that item. In addition, in this example, the group of information 207a includes a visual indicator 208a of the corresponding entity performing the activity, which in this example is a logo of the CIS Service. The user-selectable controls 209a include the ability for the current user to indicate that the user “Likes” or otherwise endorses the group of information 207a, to provide a “Comment” related to the information (e.g., such as may be visible to other users that also receive the group of information 207a and/or that have the current user as being a selected or associated user, to “Share” the information of the group 207a with one or more other designated recipients (e.g., via email or by adding information to a recipient's news feed), to “Follow” additional information about the activities of the current entity for group 207a (in this case, activities of the CIS Service) and/or for the particular type of statistics information that is illustrated in group 207a, to “View” additional information related to group 207a, and to “Ask” a question to obtain additional related information for a user that provides indicated information or is otherwise responsible for the indicated information. For example, the authorized user may be able to see information about actions of other selected users (e.g., boosting recommendations for a product, liking a product and/or purchase, liking or commenting on a report, etc.). It will be appreciated that such user-selectable controls may have different forms and be accessible in other manners in other embodiments, and that other embodiments may include additional controls and/or may not include some or all of the displayed controls.

The News Feed social information in section 298d further includes groups of information 207b and 207c that correspond to entries for activities performed by other related users User VVV and User WWW, respectively. The associated visual information 208b and 208c for those groups of information, respectively, include photos of those users in this example. In particular, the comment provided by User WWW ten minutes ago in the group of information 207c indicates that User WWW made a large inventory acquisition yesterday of a particular retail item (e.g., if User WWW has a role as a purchaser for Retailer RRR), and the activity shown for User VVV five minutes ago in the group of information 207b relates to boosting the frequency or other visibility of content items corresponding to three indicated retail items. For example, User VVV may have a role for the online retailer organization that includes being a marketer for items in at least Category ZZZ, and may have boosted the promotion for Item MNO based at least in part on the large purchase performed yesterday by User WWW for that item (e.g., based on the group of information 207c similarly being displayed to User VVV in similar restricted access information as part of the same Web page or a different Web page). The group of information 207d illustrates that the CIS Service can similarly provide a variety of other types of information related to retail activities for the Web site, such as to indicate products that are currently on the move (e.g., having increased sales trend over a defined period of time), search key words that have low conversion rates that are trending, etc. Alternatively, information such as that indicated in the group of information 207c may reflect a comment by the indicated authorized user on activity by one or more customers of Retailer RRR, such as to reflect purchase activities by the customer(s). It will be appreciated that a variety of types of activity and status information may be displayed as part of such news feed social information, including location and/or other status of particular other users.

FIG. 2F continues the examples of FIGS. 2A-2E, and in particular illustrates a Web page 200f that is specific to a particular user. In particular, Web page 200f and similar other user-specific Web pages may be provided by the CIS Service and/or by the online retailer to enable each authorized user to further obtain additional personalized restricted access information for that user, such as that may be displayed separately from other retail Web pages provided by the online retailer (or alternatively may be displayed as part of other restricted information 298 in other embodiments, such as part of section 298d). In this example, the Web page 200f is specific to User UUU, and includes a first section of information 204a corresponding to the user and his or her role for the online retailer, including a photo 208d of the user.

In the illustrated example, the Web page 200f further includes reports information 204b and associated people information 204c that may be specific to User UUU, such as based on previous definitions or selections by User UUU. For example, the information in the reports section 204b may correspond to particular defined types of reports that reflect particular types of analytics information or other types of merchandising-related information for Retailer RRR that are of interest to User UUU, and may be displayed in various manners (tables, graphs, pie charts, etc.). The information section 204b further includes a control in the illustrated example to add additional reports to be displayed in the section 204b. In a similar manner, the section 204c includes information about other users that are associated with User UUU, such as based on previous selections of those other users by User UUU (e.g., based on selection of the “Follow” controls 209b and 209c of FIG. 2E) or other types of association between User UUU and those other users, and similarly includes a user-selectable control for User UUU to select one or more additional users of interest. In some embodiments, all of the information in sections 204b and 204c may correspond to information and users that are associated with Retailer RRR (e.g., users that are employees of the retailer, and confidential information related to business operations of the retailer), while in other embodiments other types of users and/or information may be selected and integrated in such information (e.g., users from one or more external social networking sites that are not specific to Retailer RRR, information from one or more external sources that do not correspond to operations of Retailer RRR, etc.). Use of the information displayed in sections 204b and 204c may enable the user to, for example, select a particular other user that the current user follows and view additional information about that other user (e.g., comments by that other user, information shared by that other user, actions taken by that other user, etc.), remove a previously selected other user and/or report, set up alerts for reports about retail items that are out of stock in their category or other area of responsibility, view another specified user's news feed to see some or all information there (e.g., that other user's reports, selected users, actions, comments, likes, etc.), etc.

The illustrated example Web page 200f further includes a section 204d that includes user activity information similar to that of the News Feed social information of FIG. 2E. In addition, the information in section 204d further illustrates activities by the current user, such as a comment 209d provided by User UUU related to the first listed group of information (e.g., based on prior selection of the “Comment” control just above the comment 209d), and with corresponding status information 207d illustrated at the beginning of the group of information. In addition, the section 204d also includes conversation information 209e corresponding to the second indicated group of information, such as to reflect a question made by an indicated user (e.g., using an “Ask” control) and a corresponding answer provided by the user to whom the group of information corresponds. Information 207f further illustrates an additional type of activity information, such as to reflect a comment or proposal made by a particular user corresponding to indicated Categories CCC and DDD. Such a comment or proposal may be automatically determined to be relevant for User UUU (and thus included in information 204d) based on the user's role related to merchandising for Category CCC, as reflected in information 204a. It will be appreciated that a variety of other types of information may be displayed on such a user-specific Web page, and that these and/or other types of information may be provided for a user in other manners in other embodiments.

FIG. 2G continues the examples of FIGS. 2A-2F, and in particular illustrates a modified version of Web pages 200a and 200c previously discussed with respect to FIGS. 2A and 2C, respectively. In particular, in the example of FIG. 2G, tab 299d corresponding to Item ABC continues to be selected, but the Placements information tab 299g of the first group of controls 298b is currently selected in this example. As discussed in greater detail with respect to FIG. 2C, the restricted access information 298 that is provided to an authorized user may include various types of user-selectable controls to enable the user to interact with the displayed restricted access information 298 to obtain additional information and related functionality, including control in tabs 298b and 298c, and/or controls included as part of the information shown in section 298d. In the example of FIG. 2G, two alternative techniques are illustrated in which an authorized user may perform activities to initiate or control the display of restricted access information, such as to cause placement-related information related to tab 299g to automatically be displayed for a particular one or more content items indicated by the user. While particular example placement-related information is not illustrated in section 298d of FIG. 2G, FIG. 2H includes additional information about possible types of placement-related information that may be displayed.

As a first example, content item 226a of FIG. 2A has been modified in Web page 200g to be content item 226g, which in this example includes a user-selectable indicator 230g corresponding to the CIS Service. The indicator 230g may, for example, be a logo of the CIS Service that is automatically added to the content item to be visible to the current user, based on the user being determined to be authorized to receive corresponding restricted access information, such that the user may click on or otherwise select the indicator 230g to cause corresponding information to be displayed in section 298d of the restricted access information 298. For example, such corresponding information may be specific to content item 226g, to the Top Selling Items section 215b, etc. In addition, while the visual indicator 230g is illustrated with respect to only one of the content items in this example, in other embodiments some or all of the other content items will also be modified in the same or a similar manner. It will be appreciated that the visual representation of a content item may be modified in other manners in other embodiments, and that in some embodiments the restricted access functionality may be provided without modifying the visual representation of the displayed content items. The CIS Service may also enable the restricted access functionality in some embodiments and situations by replacing one or more displayed content items with a specified restricted access functionality content item (not shown in this example), whether instead of or in addition to modifying one or more displayed content items.

Icons 202a and 202b illustrate an alternative technique via which the user may select and obtain information corresponding to one or more displayed content items, whether instead of or in addition to use of one or more indicators such as 230g. In particular, in the illustrated example, the current user has moved a pointer or other selector (a mouse pointer, a finger or stylus on a touch-sensitive screen, etc.) from location 202a (which is not associated with any user-selectable information of Web page 200g) to location 202b (which is over or otherwise associated with content item 216g). In the illustrated example, by performing such a movement of the pointer item (referred to as a “hover”), the user may initiate the display of corresponding information in section 298d of the restricted access information 298 corresponding to content item 216g, without clicking or otherwise performing additional activities to select content item 216g. In addition, in the illustrated example, the display of the content item 216g is highlighted or emphasized to reflect its hover-based selection, such that movement of the pointer back to location 202a (or to other locations that are not associated with the content item 216g) would cause the content item 216g display to return to its previous normal state. In other embodiments, such hover-based selection may not be used for the display of restricted access information, such as if the user instead needs to actively click on or otherwise further select a content item such as content item 216g in order to cause corresponding restricted access information to be displayed.

In some embodiments, the restricted access information 298 may be visible before the selection is made by the user of the indicator 230g and/or before the hover selection of content item 216g is performed, such that the selection by the user causes the information displayed in section 298d to be updated to reflect corresponding information and/or causes Placements tab 299g to become selected, while in other embodiments the restricted access information 298 may not be visible until selection by the user of the indicator 230g or until the hover selection of content item 216g is performed. In addition, while the placement-related information in FIG. 2G is displayed with respect to one or more content items that are already part of Web page 200g (e.g., content items 216-219 and/or 226-229), other types of placement-related information may be displayed for other types of Web pages in other embodiments and situations. For example, consider a situation in which an alternative Web page similar to page 200g is displayed, but in which the alternative Web page is not yet configured to include any such placement content items (e.g., the alternative Web page does not include any recommendations, advertisements or promotions information selected by the CIS Service for inclusion on the alternative Web page) and/or in which the CIS Service is not yet configured to provide any such placement content items for inclusion on the alternative Web page. In such a situation, in some embodiments, additional information 298 may be displayed for the alternative Web page to an authorized user to indicate one or more types of possible placement-related information for the alternative Web page that is not yet present, such as from the following non-exclusive list: one or more specific recommendations, advertisements and/or promotions that the CIS Service would include on the alternative Web page if so configured (e.g., based at least in part on other information of the alternative Web page, such as information about one or more available products); one or more categories or types of recommendations, advertisements and/or promotions that the CIS Service would include on the alternative Web page if so configured; projections or estimates of results of the CIS Service including recommendations, advertisements and/or promotions on the alternative Web page (e.g., additional revenues, sales, etc.); user-selectable controls to enable the authorized user to configure the alternative Web page to include recommendations, advertisements and/or promotions that are selected by the CIS Service on future displayed copies of the alternative Web page; user-selectable controls to enable the authorized user to configure the CIS Service to select and provide recommendations, advertisements and/or promotions for future displayed copies of the alternative Web page; user-selectable controls to enable the authorized user to request the inclusion by the CIS Service of recommendations, advertisements and/or promotions on the alternative Web page (e.g., by sending a request from the authorized user to an appropriate user representative of the CIS Service and/or of Retailer RRR to authorize or otherwise initiate inclusion by the CIS Service of recommendations, advertisements and/or promotions on the alternative Web page); similar types of information and/or controls to those previously mentioned but for a category or group of multiple Web pages to which the alternative Web page belongs; etc.

FIG. 2H continues the examples of 2A-2G, and includes a version of restricted access information 298 with example placement-related information corresponding to Item ABC. In particular, in this example, tabs 299g and 299d have been selected, such as based on selection by the user of one or more of those tabs via the displayed information 298, or instead by another activity such as a selection activity of indicator 230g of FIG. 2G or a hover-related selection activity corresponding to location 202b of FIG. 2G. The information section 298d of the restricted access information 298 of FIG. 2H has been updated accordingly to include various types of details about promotional activities performed related to Item ABC, including activities performed by the CIS Service on behalf of the online retailer and/or other entities (e.g., advertisers, manufacturers, etc.). In particular, the information in section 298d in FIG. 2H includes various information 235 corresponding to one or more promotional campaigns that are currently active for or otherwise associated with Item ABC and that are used to select one or more displayed content items for Item ABC, and further includes information 260 providing additional information about one or more particular content items that are displayed for Item ABC, as well as to optionally include additional analytics information (not shown) corresponding to results of the use of the campaign(s) and content items so far.

In this example, the campaign-related information 235 includes an indication 240a of a particular campaign and various additional information corresponding to that campaign, including information about how and when the campaign will be used to influence the selection and display of corresponding content items, as well as various controls for the user to change aspects of the campaign. The illustrated controls include user-selectable controls 245c and 245d for the user to change the status of whether the indicated campaign is active or not. In this example, the additional information includes additional user-selectable controls to change filters and criteria associated with the campaign. The campaign-related information includes, for example, information 245a about time periods during which the campaign is effective, as well as a user-selectable control 245b with which those time periods may be changed. In addition, other of the additional campaign-related information in this example includes indications of geographic regions of users to which one or more content items for the campaign are to be displayed, information about how often such campaign content items are to be displayed for the campaign, contextual information about product/service items with which such campaign content items should be displayed (in this example, either items from Brand LLL of a particular item type, or any items from Category ZZZ, along with customers having one or more specified attributes, such as particular spending habits and/or demographic information), and a ranking of a current product item with respect to a relevance measure for selecting which product items are most relevant for the campaign. Thus, the illustrated information indicates that the campaign may be used with Web page 200g of FIG. 2G because the Web page is for a product item that matches the campaign criteria (i.e., is an item from Brand LLL that is of the specified type, or is part of Category ZZZ), and Item ABC is sufficiently relevant for the corresponding relevance measure. In some embodiments, various additional details may be displayed regarding why this campaign was selected for current use.

In this example, the content item-related information 260 is specific to a particular selected content item (e.g., content item 226g of FIG. 2G, if selected via indicator 230g, or content item 216g of FIG. 2G, if selected via a hover-related selection at location 202b), although in other situations may include information and controls related to multiple content items. The information and controls in this example include informational control 255a to enable the user to select to obtain information about why the selected content item is currently selected for use on this Web page, and similar controls to enable the user to obtain information about the effectiveness of the selected content item (e.g., information about click-through rates and conversion rates of consumer users, corresponding gross and/or net revenue corresponding to such actions, etc.), to remove or boost the use of the selected content item with Item ABC, to lock use of the selected content item with the corresponding recommendation strategy with which it was used, etc. The content item-related information 260 further may include information and controls that are not specific to any particular selected content item, such as control 265a to enable the user to select to alter or otherwise influence content items to be selected in the future for one or more Web pages of the retailer, and other controls to enable the user to select to obtain information about the effectiveness of various content items for the current Web page. FIG. 2I provides a further example of additional restricted access information and controls that may be displayed based on selected of control 265a.

It will be appreciated that placement-related information may be displayed in other manners in other embodiments, such as to display only one of the types of information 235 and 260 and/or to display one or more additional types of information, whether instead of or in addition to information 235 and 260. In addition, in some embodiments the placement-related information may be further separated into types of content items, such as to provide separate information for recommendations, advertisements, promotions, and other types of content items. Furthermore, in some embodiments, the CIS Service may initially default to display information about each placement content item that is included on an associated Web page, such as a click-through rate, a conversion rate, an engagement rate, CPM (cost per thousand impressions), total 10 (insertion order) value, length of campaign, amount of impressions purchased, etc., and optionally may include additional sitewide information about performance of placement content items (e.g., customer segments, control groups, CPM level, average click-through rate, control group conversion, campaign user changes, etc.). In some embodiments, some or all such placement-related information may be available only to a client of the CIS Service who defined a campaign (e.g., controls that provide the ability to modify the campaign) or otherwise caused a particular content item to be displayed, and/or to users who are representatives of retailer RRR (e.g., to enable Retailer RRR to determine why a particular content item was selected for display on this Web page and/or to alter future display of content items on the retailer's Web pages).

FIG. 2I continues the examples of FIGS. 2A-2H, and in particular illustrates additional restricted access information 298 to provide additional placement-related information and controls. In particular, in the example of FIG. 2I, the placement-related information in section 298b may be displayed based on selection of user-selectable control 265a of FIG. 2H, based on selection by the user of tab 299h to initiate the display of Sitewide placement-related information, or may instead be initiated in other manners.

In this example, restricted access information displayed in section 298d Of FIG. 2I enables the user to specify various types of filters or other restrictions 275a by which content items will be selected in the future by the CIS Service for use on retailer RRR's Web site, as well as other controls 275b-275d to enable the user to access other types of functionality and controls. In particular, in this example, the restrictions 275a include controls 280a to specify parts of retailer RRR's Web site to which the restrictions will apply, and controls 280b to specify types of content items for the CIS Service to select for those specified parts of retailer RRR's Web site. In this example, the user has selected control 285a to specify that the restrictions apply to the Web page for product Item ABC, and has selected control 285b to specify that the content items for that specified Web page are to be filtered by category of product/service items. In response to such selections, additional information (not shown) may be displayed to the user to enable the user to specify one or more particular product/service item categories from which content items may be selected for display on the specified Web page and/or to specify one or more particular product/service item categories from which content items may not be selected for display on the specified Web page. By selecting other of the controls 280a and 280b, the user may specify related restrictions for other Web pages and/or for particular recommendation display locations on Web pages (e.g., for display location sections 215a and/or 215b of FIG. 2A), including with respect to restrictions on particular product/service items for which content items may be selected or not selected and/or with respect to various attributes of such product/service items or related content items.

While not illustrated here, various other types of restrictions may further be specified, such as to target particular types of content items to particular customer users of the retailer RRR's Web site. In addition, the other controls 275b-275d in this example enable the user to access other functionality and controls related to historical sales reports for retailer RRR based on prior display of selected content items, various additional drilldown details related to prior or current selection of content items, and information about an account of the affiliated retailer RRR user with the CIS Service, and various other types of functionality and controls may be provided in other embodiments.

FIG. 2J continues the examples of FIGS. 2A-2I, and in particular corresponds to the display of modified restricted access information 298 for an example Web page 200j. In particular, Web page 200j is similar to Web page 200c of FIG. 2C, but the All tab 299i is currently selected, and the second row controls 298c are not displayed in this example embodiment. For example, the user may have initiated the display of information corresponding to the All tab 299i based on selection of that tab, or the tab 299i may instead have been automatically selected by default by the CIS Service for display to the user in the current situation or context of Web page 200j. In this example, the restricted access information that is displayed in section 298d may include a combination of various other types of information previously discussed with respect to the Analytics information, Placements information, and News Feed social information tabs, such as to include information about all of those types in the section 298b. In addition, while not illustrated with respect to FIG. 2J, the information in section 298d may further include various user-selectable controls to enable the user to modify and further control the display of additional restricted access information and to otherwise obtain access to restricted access functionality, as discussed in greater detail elsewhere.

By enabling an authorized user to access information and controls from particular parts of retailer RRR's Web site, the user may be enabled to more efficiently access and control desired information, such as based at least in part on a current context of the user when interacting with a particular part of retailer RRR's Web site. For example, as discussed elsewhere, the CIS Service may additionally provide a separate GUI that the user may access by interacting directly with the CIS Service to specify restrictions for various parts of retailer RRR's Web site and/or to determine information about the selection of particular content items in particular locations (e.g., information about why those selections were made, about the effectiveness of those content item selections, etc.). However, using such a general GUI, a user may need to make a number of selections and navigational actions to reach information that is specific to the Web pages displayed in various of FIGS. 2A-2J for the particular product item ABC. Conversely, by providing the restricted access functionality described with respect to FIGS. 2C-2J, the user may identify a particular part of retailer RRR's Web site of interest, and obtain information about particular content items that are currently selected for display, about particular merchandising-related information corresponding to the current display, and/or about particular social information corresponding to the current display—in addition, the user may in some embodiments immediately access controls related to the current Web page, such as to influence future related content item selections. In this manner, a more intuitive user interface may be provided, and in some embodiments and situations, access to additional information and/or controls may further be provided that may not be otherwise accessible.

It will be appreciated that various of the details illustrated in FIGS. 2A-2J are included for explanatory purposes, and that the inventive described techniques may be used in other manners and without the exemplary details.

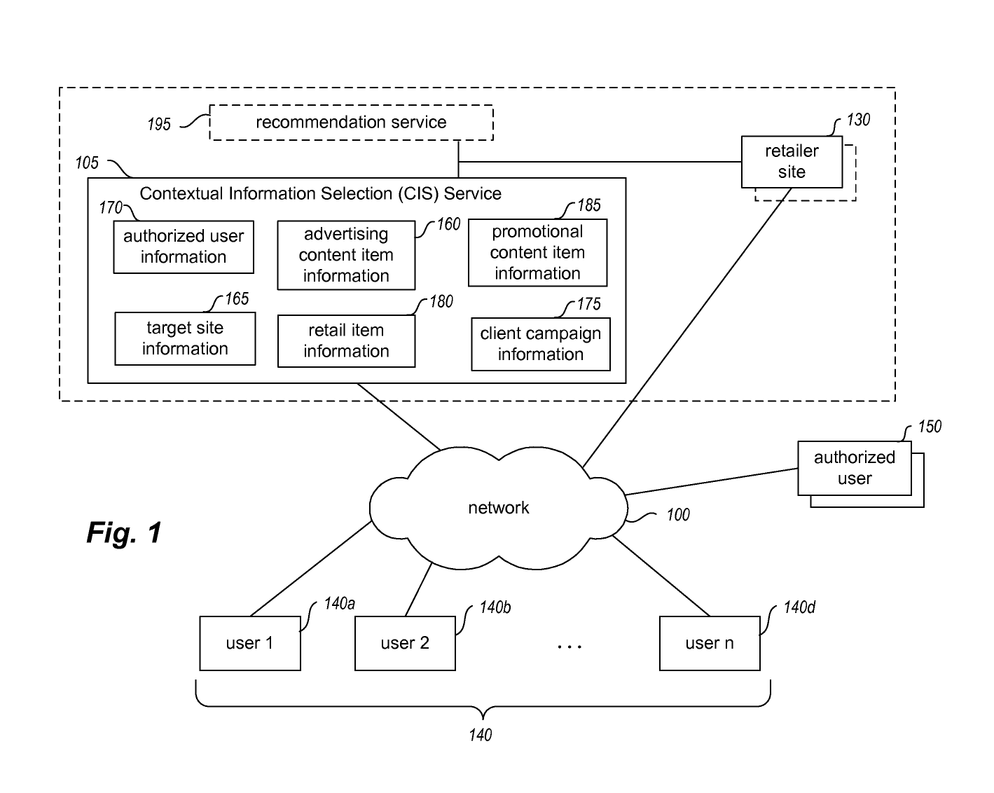

FIG. 1 is a network diagram illustrating an embodiment of a Contextual Information Selection (CIS) Service for providing authorized users with restricted commerce-related information and associated functionality via corresponding Web pages of an online retailer or other online commerce site. In some embodiments, the CIS Service may further dynamically select content items to use in particular situations, and enable user analysis and control of the content item selection in various manners. With respect to at least some embodiments below, the discussion may refer to products and online retailers, but it will be appreciated that the same or similar techniques may be applied to other types of items and for other types of uses in other embodiments.

The illustrated example of FIG. 1 includes a number of example users 140 that are each interacting with one or more Web sites or other target sites 130 over one or more intervening networks 100, such as to obtain Web pages or other electronic information from those target sites 130, and to optionally engage in commerce activities with those target sites 130. In particular, some or all of the example target sites 130 may be provided by one or more online retailer businesses that sell or otherwise make products or other items available to customer users or potential customer users, such as via a Web site or other network-based service hosted on one or more server computing systems. For example, the users 140 may access a Web site 130 of a retailer to obtain one or more Web pages, such as to view information about, search for, browse for, rate, place an order for, and/or provide information for completing a purchase of or a return of one or more products or other items available from the retailer. As discussed in greater detail elsewhere, the information provided to the users 140 from the retailer target sites 130 may in some embodiments include content items selected by the service 105. In addition, in at least some such embodiments, information about various of the interactions of the users 140 with a retailer Web site 130 may be collected and included by the service 105, such as interactions of the users that are related to the products or other items made available on the retailer Web site 130 (e.g., product views, purchases, returns, ratings, etc.). In other embodiments, some or all of the users 140 may obtain displayed or otherwise presented information from target sites 130 in manners other than via personal computing devices of the users, such as if those users are at a physical retail location and interact with one or more publicly accessible device(s) at the physical retail location (e.g., a fixed-location kiosk provided by the retailer, a mobile wireless device belonging to the retailer, etc.) in order to view and/or interact with product information and related content from the retailer.

As part of providing Web pages to users, the target sites 130 in this example have previously established an affiliation with an example embodiment of the CIS service 105, such as to enable the CIS service to provide restricted access information to authorized users in a contextually appropriate manner, and in some embodiments to select and provide content items (e.g., content items associated with particular selected products) for display on at least some of the Web pages provided by the target sites 130 to users. The target sites 130 and/or the CIS service may similarly have previously established an affiliation in this example with one or more other optional product/service item recommendation services 195 (e.g., services that provide targeted product recommendations for particular users and/or particular situations), and if so the services 105 and/or 195 may select and optionally provide particular content items in particular situations. The interactions between a target site, a user 140, the CIS Service 105 and the other services 195 may occur in various manners in various embodiments, such as for a target site to request the selection of one or more content items for presentation to one or more users, for a user's computing device to request one or more selected content items for presentation to the user (e.g., upon display of a Web page or other information from a target site), etc. In addition, a particular target site 130 may interact with only one of the service 105 and a service 195 in some embodiments, with that service interacting as appropriate with the other service before responding to the target site 130. Alternatively, the target site 130 may interact with both of the service 105 and service 195, the service 105 and service 195 may in some embodiments be integrated as a single service, or the optional other services 195 may not be used. In yet other embodiments, the service 105 may have other forms, such as to be included as part of a particular target site 130 (e.g., to provide the described techniques for that target site on behalf of its users). In addition, in some situations and embodiments, some or all of the users 140 may optionally interact directly with the CIS Service 105, such as to request and receive particular selected content items from the CIS Service 105 (e.g., based on a request initiated by the user; based on a request initiated by a Web page provided to the user from a target site 130, such that display or other presentation of the Web page on the user's computing device, not shown, causes the request; etc.).

The example network 100 may have various forms. In this example, the network 100 is a publicly accessible network of linked networks, possibly operated by various distinct parties, such as the Internet, although in other embodiments the network 100 may have other forms. For example, the network 100 may instead be a private network, such as, for example, a corporate or university network that is wholly or partially inaccessible to non-privileged users. In still other embodiments, the network 100 may include both private and public networks, with one or more of the private networks having access to and/or from one or more of the public networks. Furthermore, the network 100 may include various types of wired and/or wireless networks in various situations. In this illustrated example of FIG. 1, the users 140 may each use computing systems and/or devices (not shown) to interact with the target sites 130 and optionally the service 105 to obtain various described functionality via the network 100, and in doing so may provide various types of information to the service 105.

In addition, various authorized users 150 may also interact with the CIS Service 105 and/or various retailer sites 130 over the network 100 in the illustrated embodiment in order to obtain restricted access information of various types, including based on display of Web pages or other information pages from the target sites 130. For example, at least some of the authorized users 150 may represent clients of the CIS Service 105 who provide or otherwise designate particular content items to be displayed to users in particular manners, such as to specify particular campaigns associated with content items and/or product/service items in exchange for fees paid by those clients—such interactions of those users with the CIS Service 105 may occur in various ways in various embodiments, such as, for example, in an interactive manner via a GUI that is provided by the CIS Service 105 and displayed on computing systems and/or other devices of those users 150, or in a programmatic manner via an API (“application programming interface”) provided by the CIS Service 105 that allows computing systems and/or programs of those users 150 to invoke such functionality programmatically, such as using Web services or other network communication protocols. In addition, at least some of the authorized users 150 may represent retailer sites or other target sites 130 that are affiliated with the CIS Service 105, such as to obtain information about merchandising-related information for the target sites, to obtain social information about activities of other authorized users, to analyze and control how content items are selected for display on their sites and to analyze the effects of such selection, etc. Such affiliate authorized users may similarly interact with the service 105 in various ways in various embodiments, such as, for example, in an interactive manner via a GUI that is provided by the CIS Service 105 and displayed on computing systems and/or other devices of those users 150, or in a programmatic manner via an API provided by the CIS Service 105 that allows computing systems and/or programs of those users 150 to invoke such functionality programmatically, such as using Web services or other network communication protocols. In addition to interacting directly with the CIS Service 105 to obtain access to various restricted information and controls, at least some such authorized users may further obtain access to some or all such restricted information and controls via various target sites 130, as discussed in greater detail below. As part of interacting with such authorized users, the CIS Service 105 may use various authorized user information 170 to determine whether a particular user is authorized to obtain any restricted access functionality, and if so to determine what restricted access functionality to provide in a particular situation.

The example CIS Service 105 of FIG. 1 may have access to various information used in providing restricted access information and/or in the selection of particular content items in particular situations. In particular, the service 105 and/or recommendation service(s) 195 have access to information about various content items that are available for display via the target sites 130 in this illustrated example, such as may be included as part of the advertising content item information 160, the promotional content item information 185, the retail item information 180 (e.g., various retail item information, such as a database and/or other data collection related to a catalog of product items and/or service items available from one or more retailer target sites 130 that may optionally include descriptions, prices, availability and other information about the products and/or services, such as to enable identify retail item recommendations to be identified), and/or other similar information (not shown) of the service(s) 195—such information may include some or all of the actual content items that will be selected and then provided by the CIS Service 105 (e.g., as previously received from clients as part of campaign definition activities) and/or may include information about content items to enable content item selection techniques to be performed, but with the actual content items stored elsewhere (e.g., by the target sites 130; on the computing devices of users 140 and/or of authorized users 150; on other network-accessible computing or storage systems, not shown; etc.). Some or all of the content items in this example may be advertisements related to products available from the retailer target sites 130, although in other embodiments and situations, some or all of the content items may not correspond to products available from the retailer target sites 130 (e.g., may be advertisements for other products or services, such as other products/services that are competitors to or complementary to products/services available from the retailer target sites 130, or instead may be one or more types of non-advertisement information).

In addition, in this example, the CIS Service 105 includes additional information to enable the described techniques, including information 165 specific to particular target sites (e.g., information about particular target site Web pages or other locations on which selected content items may be displayed), client campaign information 175 related to defined content item visibility campaigns of clients, and optionally other information that is not illustrated (e.g., historical user interaction information, such as to determine expected values of displaying content items to users based on expected click-through rates and/or conversion rates; historical sales information and other merchandising information related to particular target sites; real-time or near-real-time merchandising and/or user interaction information for particular target sites; etc.). Additional details related to such information and its use are included elsewhere.

At least some authorized users 150 may obtain access to some or all restricted access information and associated controls and functionality via various target sites 130, whether in addition to or instead of interacting directly with the CIS Service 105 to obtain such restricted access functionality. In particular, in a manner similar to users 140, those authorized users 150 may each interact with one or more Web sites or other target sites 130, such as to obtain Web pages or other electronic information from those target sites 130 (e.g., Web pages from a retailer target site 130 about particular product/service items that are available for purchase or other acquisition via the retailer target site 130). As discussed in greater detail elsewhere, the information provided to the authorized users 150 from the retailer target sites 130 may include restricted access information of various types that is not available to the users 140. For example, after it is determined that a user to whom a target site 130 is providing information is an authorized user 150 (e.g., by the CIS Service 105 determining the identity of that user based on interactions of that user with user-selectable controls provided by the CIS Service for display via one or more Web pages of the target site 130, or instead in other manners), the CIS Service may perform actions to determine a level or type of access of that authorized user 150 to restricted access information in the current context (e.g., to enable an authorized user associated with a first target site 130 to obtain certain types of restricted access functionality while interacting with the first target site 130, but to optionally not receive some or all such restricted access functionality while interacting with other target sites), and then provide at least some of that restricted access functionality to that authorized user via that target site in that context. In some embodiments and situations, access of an authorized user to at least some types of restricted access functionality via a target site 130 may redirect that authorized user to engage in various subsequent interactions directly with the CIS Service 105, and optionally to return to the prior interactions with the target site 130 after those restriction functionality access interactions are completed.

As previously noted, placement content items that are available to be selected may be of various types in various embodiments. Such content items may include advertisements or other promotional materials in at least some embodiments, such as for particular items, brands and/or related companies (e.g., item manufacturers, distributors, wholesalers, etc.), and may in some such embodiments be supplied by or otherwise indicated by particular clients (e.g., by one or more of the related companies for particular product items and/or service items that the companies provide or otherwise promote). In addition, such content items may have various forms, such as for a particular content item to include one or more of text, one or more images, one or more videos, one or more audio clips, one or more user-selectable controls, one or more associated operations to be performed in response to particular actions by users to whom the content item is presented (e.g., by the user clicking on or otherwise selecting the content item), etc. The selecting of particular content items by the CIS Service may also in some embodiments be performed in accordance with campaigns of particular companies or other entities that are clients of the CIS Service, such as based on fees paid by those companies to promote visibility of particular promotional materials in accordance with particular campaign criteria specified by the companies, as discussed in greater detail below. Thus, content items may in some embodiments include promotional materials or other types of information that are selected by the CIS Service and displayed to users in particular situations, including with other information from one or more other third-party target sites (e.g., as part of Web pages provided by those other target sites).

The target sites on which content items and restricted access functionality may be provided may also have various forms in various embodiments. For example, target sites used in a particular embodiment may include one or more of the following non-exclusive list: online retailer Web sites (e.g., which may each provide numerous Web pages that are each specific to one or more particular items, such as to enable consumer users to purchase those items from the site); other types of commerce Web sites (e.g., an online travel commerce site, an online automotive commerce site, an online commerce site of a financial organization, an online commerce site that provides access to digital content, etc.); other non-retailer Web sites that include information about particular items (e.g., review or opinion sites, encyclopedia or other general knowledge sites, search engines that include item information in search results, etc.); other Web sites that include information that is not specific to particular items (e.g., general news sites); and other electronic sites that are accessible in manners other than via the Internet (e.g., an application store or other electronic marketplace that is provided by a cellular telephone network provider and is accessible by devices connected to the cellular network; an electronic store or other marketplace that is provided to users of a specialized type of computing device, such as game consoles connected to a manufacturer-provided electronic store; etc.). In addition, the target sites may have various types of contractual relationships or other affiliations with the CIS Service, including arrangements in which the target sites are paid by the CIS Service for allowing selected content items to be presented on their sites and/or in which the CIS Service is paid by the target sites for selecting and providing content items to be presented on their sites. For example, in embodiments in which at least some of the content items include promotional materials, the CIS Service may operate as part of a service that provides advertisements for display on one or more target sites (e.g., on item-related pages provided by an online retailer target site), or the CIS may otherwise be affiliated with one or more such advertisement-providing services—in addition, in at least some such embodiments, the content item selection techniques of the CIS Service may operate in conjunction with other techniques for selecting advertisements for display (e.g., pay-per-click or pay-per-view systems, such as based on bids supplied by advertisers), such as to supplement, adjust and/or replace the other advertisement selection techniques, as discussed in greater detail below.

The identification of authorized users and the corresponding providing of restricted access information and/or user-selectable controls to such users may be enabled in various manners. For example, the CIS Service may in at least some embodiments provide an executable script or other information for use as part of a Web page from a target Web site to enable the authorized user to perform login or other identification activities and/or to enable the restricted access information and associated functionality to be provided to the authorized user. Such an enabling script or other information may, for example, be provided to the target site by the CIS Service before the Web page is provided to users, such as to enable the target site to integrate the provided enabling script or other information as part of one or more Web pages from the target site. Alternatively, such an enabling script or other information may, for example, be dynamically provided by the CIS Service as part of a particular Web page, such as along with one or more content items and/or restricted access information being provided for that Web page.

The restricted access information and associated functionality that may be provided to authorized users by the CIS Service may have various forms in various embodiments. The providing of restricted access information and associated functionality may include, for example, one or more actions of the following non-exclusive list: display of one or more user-editable fields as part of the Web page or instead separately (e.g., as part of a separate window, such as a pop-up window), such as to allow the user to enter information that will be transmitted to the CIS Service (e.g., login information or other identifying information); display of one or more types of restricted access information related to the selection and use of one or more selected content items (e.g., a particular content item that is selected to initiate the restricted access functionality), such as information about why those one or more content items were selected, information about historical promotional effectiveness of those one or more content items or other related analytics information, information about campaigns with which the content items are associated and related campaign criteria, etc; display of one or more types of restricted access information related to the selection and use of content items with a current Web page and/or with related Web pages, such as information about historical promotional effectiveness of content items displayed on the current Web page and/or on related Web pages (e.g., multiple Web pages that correspond to a category or genre of product/service items, that correspond to a particular online retailer or other target site, etc.); display of other restricted access information specific to the authorized user, such as information about an account of the authorized user with the CIS Service; and display of one or more restricted access user-selectable controls to enable the authorized user to alter or otherwise influence the future selection of content items for this Web page and/or related Web pages (e.g., multiple Web pages that correspond to a category or genre of product/service items, that correspond to a particular online retailer or other target site, etc.). The restricted access user-selectable controls may, for example, enable an online retailer authorized user to perform one or more of the following non-exclusive list: specify filters on the content items to be selected and use for one or more of the Web pages of the online retailer's target site, such as filters related to attributes of the product/service items with which the content items are associated (e.g., based on price, product/service category or genre, brand, manufacturer, etc.), including to prevent particular content items from being selected for use on some or all parts of the target site or to otherwise prevent particular product/service items from being advertised on some or all parts of the target site; specify instructions related to targeting particular content items (e.g., to target the selection and use of particular content items or content items with particular attributes, including having particular associated product/service items, to specified users or to users with specified attributes, to specified product/service items or product/service items with specified attributes, to specified Web pages or to Web pages with specified attributes, etc.); specify instructions related to the selection of particular content items or content items with particular attributes, such as to positively or negatively boost the likelihood of those content items being selected (e.g., to positively or negatively boost the otherwise determined relevance of those content items as being recommended for particular situations), including to recommend that content items associated with a specific product/service item category or genre be selected and used with Web pages for particular other complementary product/service items or category/genres; etc.

Use of the described techniques may provide various benefits to users, including efficient access to restricted access information and/or associated functionality. As noted above, in at least some embodiments and situations, the described techniques include providing restricted access information and/or associated functionality to at least some users while those users are interacting with Web pages or other information from a particular retailer Web site or other target site, such as to provide restricted access information and/or associated functionality that is based at least in part on a current context of the user. By enabling a user to access restricted access information and/or controls from particular locations of an online retailer's Web site or other target electronic commerce site, the user may be enabled to more efficiently access and control desired information.

In addition, different authorized users may be provided with different types of restricted access information and/or associated functionality in at least some embodiments. For example, if one or more content items that are part of a first client's campaign are selected for display on a Web page of a target Web site of a second online retailer, a user representative of the first client may be provided with restricted access functionality to review and modify various details of the first client's campaign but not to control how other clients' content items are displayed on the target Web site, while a user representative of the second online retailer may be provided with restricted access functionality to specify various controls regarding how various content items are displayed on portions of the target Web site but not to otherwise alter the first client's campaign or control how content items are selected for other target sites. In addition, a first user representative of the second online retailer may be designated by the second online retailer as having all restricted access functionality that is available to the second online retailer, while a second user representative of the second online retailer may be designated by the second online retailer as having only a subset of the restricted access functionality that is available to the second online retailer (e.g., functionality to view restricted access information about prior content item selection but not to alter future content item selection). If different authorized users are provided with different types of restricted access functionality, the CIS Service may perform additional related types of operations, such as to determine particular restricted access functionality to particular authorized users in particular situations, including based on instructions specified by affiliated target sites and/or clients.

Various product/service item targeted recommendation strategies may also be used to evaluate the relevance of particular product/service items to recommend to particular users in particular situations. For example, the content item selection techniques of the CIS Service may in some embodiments operate in conjunction with other techniques for selecting advertisements for display, such as one or more product/service item targeted recommendation strategies. Such product/service targeted recommendation strategies may in some embodiments be based at least in part on data regarding prior interactions of numerous users with numerous items, such as the interactions of customers of one or more retailers related to products or other items that are available from those retailers, or instead interactions of other types of users in other situations (e.g., users who perform searches with search engines, users who view information about products from a product review service, etc.). A non-exclusive list of types of interactions of customers of online or other retailers with items for which interaction data is gathered may include, for example, the following: performing searches (e.g., for particular items, for items of a particular category or other defined group of items, for items having one or more indicated attributes, etc.); browsing item categories; viewing detailed information about particular items; purchasing items; doing item returns; etc. The interaction data about the prior user interactions with items may then be analyzed and summarized in various ways, such as, for example, in the following non-exclusive manners: to identify items that are popular (e.g., the top item sellers in a particular category or from a particular retailer during a particular period of time; the items that are most often selected by users, such as to view detailed information about the items; the items with the highest user ratings; the items most often included in results of users' searches and/or selected by users from such search results; the “hottest” items of an item group to reflect those items having the largest changes in their ratings or sales or other popularity measure during a particular period of time; etc.); to identify items that are similar to each other or otherwise related to each other (e.g., items that have similar or otherwise related items attributes, such as price, type, size, etc.; users who viewed this item are most likely to also view these other items; users who viewed this item are most likely to purchase these items; users who purchased this item are most likely to also purchase these other items; users who searched for this item attribute and/or browsed this item category are most likely to view and/or purchase these items or items with these attributes or items in these categories; etc.); to identify items that are popular among users similar to a user for whom targeted recommendations are being made (e.g., users with similar demographics; users in the same or nearby geographic regions, etc.); to identify items that have been explicitly associated with one another, such as by a retailer, an advertiser, a manufacturer, and/or another user (e.g., “buy together” items); to identify items that are similar or otherwise related to items interacted with by a particular user, such as a user to whom targeted recommendations are to be provided (e.g., interactions related to items purchased by the user, items viewed by the user, items added to a shopping cart of the user, etc.); etc. Some or all of the various types of analyzed or summarized user interaction data may then each be used as a distinct targeted recommendation strategy, such as to use information about top item sellers in a particular category as one targeted recommendation strategy when a user interest in that category is indicated or suspected, to use information about users who viewed a particular item as being most likely to purchase other identified items as one targeted recommendation strategy when a user interest in that particular item is indicated or suspected, etc.

Multiple recommendation strategies may be used together in various ways in various embodiments to select particular content items for particular users. For example, in some embodiments and situations, recommendation results from multiple available targeted recommendation strategies may be gathered for a particular situation involving a particular user, and then those various targeted recommendation results may be aggregated in various manners. As one example of aggregating various recommendation results from multiple recommendation strategies, the various recommendation results may be weighted or otherwise ranked, so as to determine relevance scores or other relevance levels for those recommendation results, and then some or all of those various recommendation results may be selected to be used as recommendations for that user based on those weightings or other rankings. The weighting or other ranking of various item recommendation results may be performed in various manners, such as based on a weighting or ranking provided by a particular recommendation strategy that recommended the item (e.g., with a top sellers recommendation strategy weighting the highest item seller as the top recommendation for that strategy, and progressively weighting lower sellers as lower recommendations), based on inclusion of a particular item recommendation in the results from multiple different recommendation strategies, etc. In other embodiments, relevance scores or other levels may be determined for particular recommended items in manners other than based on weighting or other ranking. In addition, in other embodiments, a particular one of multiple available recommendation strategies may instead be selected for use in a particular situation, such as based on a dynamic determination that the particular recommendation strategy is optimal or otherwise preferred for the particular situation, or instead based on a prior selection or configuration to use that particular recommendation strategy in that particular situation (e.g., based on prior configuration by a human operator, based on a prior automated selection of that particular recommendation strategy, etc.). A dynamic determination to use a particular recommendation strategy at a given time based on a current situation may be based on, for example, a comparison of the results from the recommendations of that particular recommendation strategy to recommendation results from one or more other possible recommendation strategies, a failure or other inability of other possible recommendation strategies to provide useful recommendation results or any recommendation results, etc.

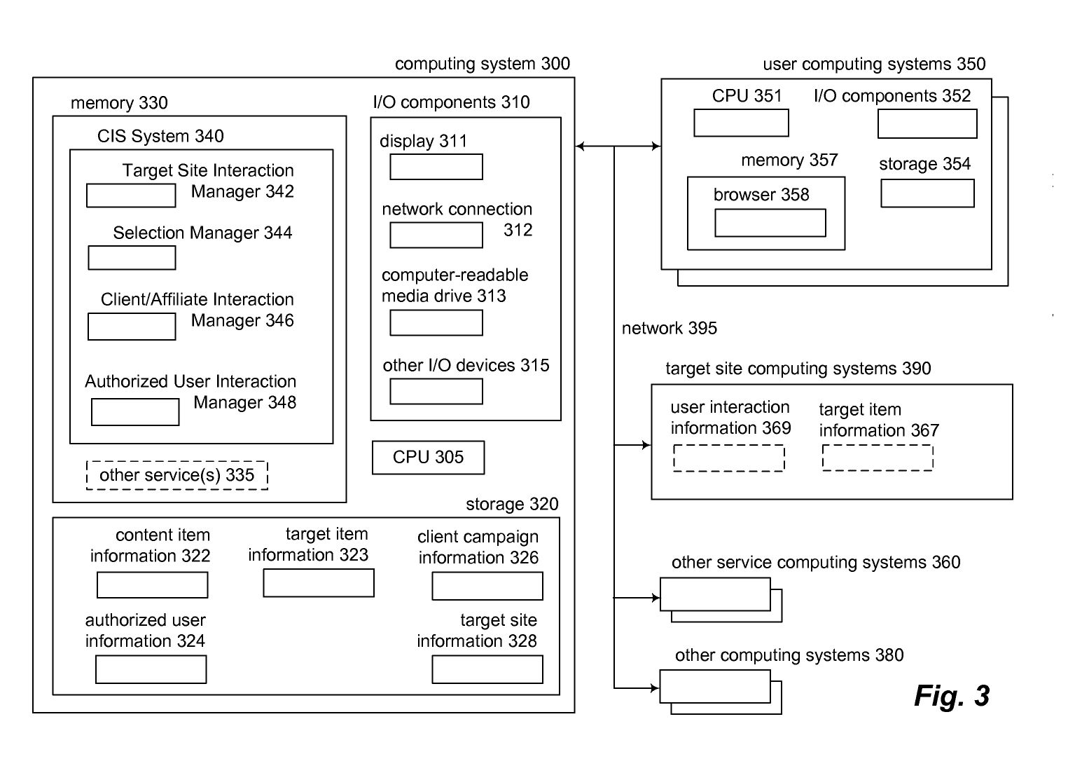

FIG. 3 is a block diagram illustrating an example embodiment of a system providing a CIS Service for performing techniques related to dynamically selecting and providing appropriate information in a contextual manner. In particular, FIG. 3 illustrates a server computing system 300 suitable for executing an embodiment of a CIS system 340 that provides a CIS Service, as well as various user computing systems 350, target site computing systems 390, other optional computing systems 360 that optionally provide other services with which the CIS system interacts, and other optional computing systems 380. In the illustrated embodiment, the server computing system 300 has components that include a CPU 305, various I/O components 310, storage 320, and memory 330. The illustrated I/O components include a display 311, a network connection 312, a computer-readable media drive 313, and other I/O devices 315 (e.g., a keyboard, a mouse, speakers, etc.). In addition, the illustrated user computing systems 350 have components similar to those of server computing system 300, including a CPU 351, I/O components 352 (although particular components are not illustrated), storage 354, and memory 357. The other computing systems 360, 380 and 390 may also each include similar components to some or all of the components illustrated with respect to computing system 300, but such components are not illustrated in this example for the sake of brevity.

An embodiment of the CIS system 340 is executing in memory 330, such as under control of one or more CPU processors 305 as programmed or otherwise configured by executable software instructions of the system 340, and a CIS Service provided by or otherwise managed by the CIS system 340 provides functionality related to some or all of the described techniques for providing restricted access information and associated functionality to authorized users. The system 340 may interact with computing systems 350, 360, 380 and 390 over the network 395 (e.g., via the Internet and/or the World Wide Web, via a private cellular network, etc.), and may dynamically select and provide appropriate information in a contextual manner to authorized users (not shown) in particular situations who are interacting with user computing systems 350. In addition, the system 340 may in some embodiments select particular content items for presentation to users (not shown) who are interacting with user computing systems 350. The information from the CIS system may in some embodiments and situations be provided directly to the user computing systems 350, while in other embodiments the information may be provided indirectly by the CIS system via one or more target sites provided by the computing systems 390 to the users and/or via other services (e.g., optional other services 335, optional other services provided by the other service computing systems 360, etc.) that interact directly with the users, such as if the users are customers of the services and/or are clients or affiliates of the CIS Service.

The other computing systems 350, 360, 380 and 390 may have various forms, and may be executing various software as part of interactions with the CIS system. For example, user computing systems 350 may include various types of client devices (e.g., a desktop computing system, a laptop or other portable computing system, a smartphone or other cell phone or other mobile device that includes appropriate communication and computing capabilities, etc.), and in the illustrated embodiment is shown executing a Web browser 358 or other software in memory 357 to interact with other computing systems (e.g., the target site computing systems) and/or the CIS system 340—while not illustrated here, such user computing systems 350 may also include another software module provided by the CIS system that is designed to enable the user to interact directly with the CIS system 340, such as another software module that is used instead of or in addition to the illustrated Web browser 358. The Web browser 358 or other software on a user computing system 350 may, for example, obtain and display Web pages or other information from target site computing systems 390—in addition, the display of that information may initiate one or more requests by the Web browser 358 to the CIS system 340 to obtain information about content items selected by a Selection Manager module 344 of the system 340, and may display or otherwise present some or all of that obtained information (e.g., via a GUI of the CIS system that is displayed to the user via one or more Web pages or other UI screens on the user computing system 350) to enable the user to interact with or otherwise use that information in various manners (e.g., to obtain additional information about associated product/service items, to initiate purchases or other acquisitions of such associated product/service items, etc.).

If a user is authorized to obtain particular restricted access functionality in a particular situation, the displayed Web pages or other information from one or more target site computing systems 390 may provide such restricted access functionality to such authorized users. The provision of the restricted access functionality may be based on interactions of an Authorized User Interaction Manager module 348 of the system 340, such as by providing such authorized users with access to restricted access information and associated functionality. In addition, one or more users of the user computing systems 350 may further interact with CIS system 340 to perform various other types of actions, such as to interact with the Client/Affiliate Interaction Manager module 346 of the system 340 to define and monitor content item visibility campaigns of clients, as discussed in greater detail elsewhere. The modules 346 and/or 348 may use and/or store various authorized user information 324 and client campaign information 326 on storage 320 as part of their operation. While not illustrated, software executing on one or more of the target site computing systems 390 may similarly interact with the CIS system 340 (e.g., with a Target Site Interaction Manager module 342 of the system 340) to obtain information about content items selected by the Selection Manager module 344 of the system 340, and may include some or all of that obtained information as part of Web pages provided to users for display, whether instead of or in addition to interactions by the user computing systems 350 with the CIS system 340.

In addition, as described in greater detail elsewhere, the CIS system 340 may in some embodiments be integrated with or otherwise affiliated with one or more other services (e.g., online retailers or other retailers, item review services, databases or other services that provide information about items and/or about user interactions with items, etc.), and if so may interact with those other services in various manners. If so, one or more such other services may, for example, execute on computing system 300 as other services 335 in memory 330, as one or more other services (not shown) that each execute on one or more of the target site computing systems 390, and/or as one or more services (not shown) that each execute on one or more of the other remote service computing systems 360. The interactions with the other services may include, for example, some or all of the following non-exclusive list: obtaining information about products and/or other items available from those services or otherwise about which the service has access to information, such as target item information 367 on target site computing system 390 and/or similar information (not shown) on other service computing system 360; obtaining information about various types of prior interactions of customers and other users with the other services or otherwise about which the other services have access to information (e.g., to view information about items; to purchase items; to provide other types of feedback about particular items or relationships between items, such as that a particular item is regarded in a particular positive or negative manner, or that two or more items are similar to each other or are otherwise related in one or more manners; etc.), such as optional user interaction information 369 on target site computing system 390 and/or similar user interaction information (not shown) on other service computing system 360; etc. The CIS system may obtain such information in various manners, such as by the CIS system pulling such information from one or more other services periodically and/or on demand, by one or more other services pushing such information to the CIS system periodically and/or as otherwise triggered (e.g., as soon as the information is available, such as to maintain a live feed so that the CIS system has access to the most up-to-date available information), etc. After such information is obtained by the CIS system, the CIS system may then store such information for later use (e.g., in databases 328 on storage 320, or on one or more remote other computing systems 380), or in other embodiments may instead retrieve the information as needed and not maintain a local copy of the information. Various other information related to the operation of the CIS system 340 may also be stored in storage 320 or elsewhere, such as information 322 about particular content items that are available for display (such as in conjunction with product/service items associated with the content items); information 326 about clients of the CIS system, including information about defined campaigns of clients of the CIS system; information 323 about retail items or other types of target items available from target sites; information 324 about authorized users; etc.

While not illustrated here, the CIS system may further have other modules or associated functionality in other embodiments, such as to generate user interaction information (e.g., based on monitoring customer users' interactions with retailers or other services; based on retrieving and processing information from retailers or other services related to such interactions, such as to identify data to be used with particular content item selection strategies; etc.). Additional details related to various operations of embodiments of the CIS system and an associated CIS Service are included elsewhere.

It will be appreciated that computing systems 300, 350, 360, 380 and 390 are merely illustrative and are not intended to limit the scope of the present invention. The computing systems/devices may instead each include multiple interacting computing systems or devices, and the computing systems/devices may be connected to other devices that are not illustrated, including through one or more networks such as the Internet, via the Web, or via private networks (e.g., mobile communication networks, etc.). More generally, a computing device or other computing system may comprise any combination of hardware that may interact and perform the described types of functionality, such as when programmed or otherwise configured with appropriate software, including without limitation, desktop or laptop or tablet or slate computers or other computers, database servers, network storage devices and other network devices, PDAs, smart phones and other cell phones, wireless phones, pagers, electronic organizers, Internet appliances, television-based systems (e.g., using set-top boxes and/or personal/digital video recorders), and various other consumer products that include appropriate communication capabilities. In addition, the functionality provided by the illustrated CIS system 340 may in some embodiments be distributed in additional modules or combined in fewer modules. Similarly, in some embodiments some of the functionality of the CIS system 340 may not be provided and/or other additional functionality may be available.

It will also be appreciated that, while various items are illustrated as being stored in memory or on storage while being used, these items or portions of them may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other manners, such as at least partially or wholly in designed and configured firmware and/or hardware means, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions contents or structured data contents) on a non-transitory computer-readable storage medium, such as a hard disk or flash drive or other non-volatile storage device, volatile or non-volatile memory (e.g., RAM), a network storage device, or a portable media article (e.g., a DVD disk, a CD disk, an optical disk, a flash memory device, etc.) to be read by an appropriate drive or via an appropriate connection. The systems, modules and data structures may also be transmitted as generated data signals (e.g., by being encoded as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

FIG. 4 is a flowchart of an example embodiment of a CIS System routine 400, such as to provide a high-level overview of some functionality of an example embodiment of the CIS Service. The routine 400 may be performed by, for example, execution of the CIS system 340 embodiment of FIG. 3, the CIS Service 105 embodiment of FIG. 1, and/or the CIS Service embodiments discussed with respect to FIGS. 2A-2J. In the illustrated embodiment, the CIS System and its routine 400 performs actions that include both selecting particular content items to display or otherwise provide to users at particular times, and to providing restricted access information and associated functionality to particular authorized users in particular situations, although in other embodiments distinct systems and/or routines may instead be used to perform the two types of functionality, or instead only one of the two types of functionality may be provided.

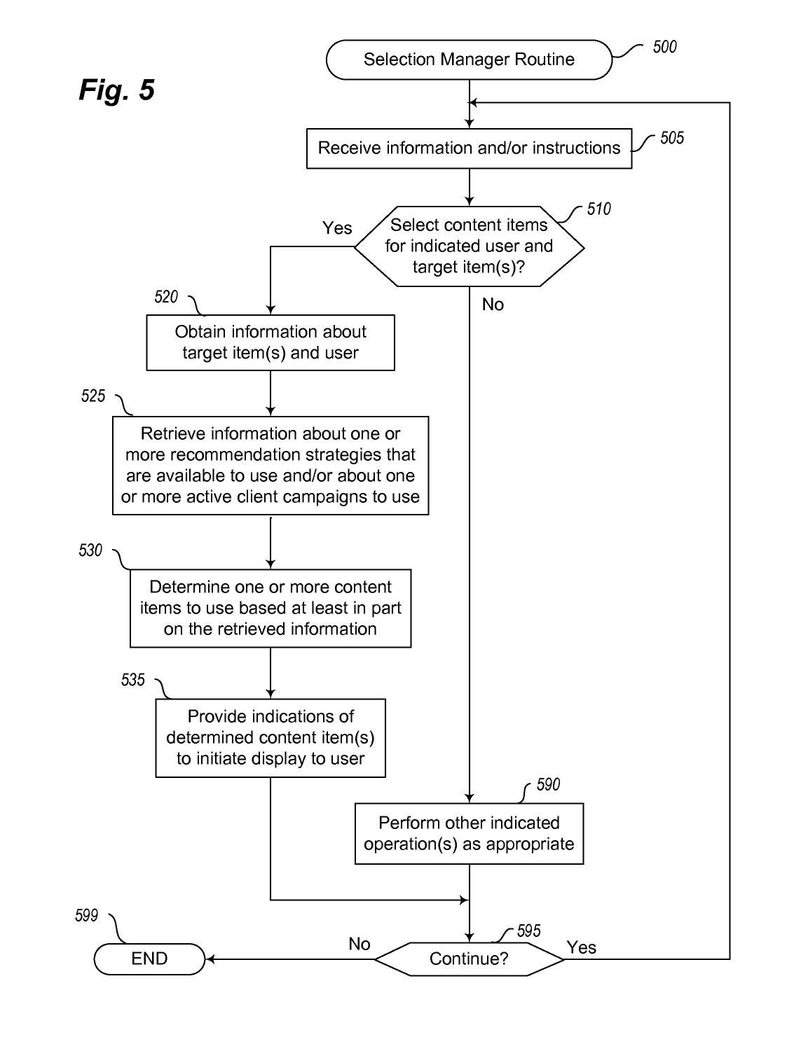

The example embodiment of the routine 400 begins at step 405, where one or more instructions and/or types of information are received. The routine then continues to block 410 to determine if a request has been received to select one or more content items to display or otherwise provide, such as for an indicated user and that correspond to one or more indicated target items or otherwise for an indicated target page of information. If so, the routine continues to block 420 to invoke a Selection Manager routine to provide corresponding functionality, with one example of such a Selection Manager routine being discussed in greater detail with respect to FIG. 5. As discussed in greater detail elsewhere, the request to provide one or more such content items may be made in various manners in various embodiments, including by a client device of a user when that user initiates display on the client device of a Web page or other information page from an online retailer or other target electronic commerce site that includes one or more embedded links or instructions to initiate such a request.

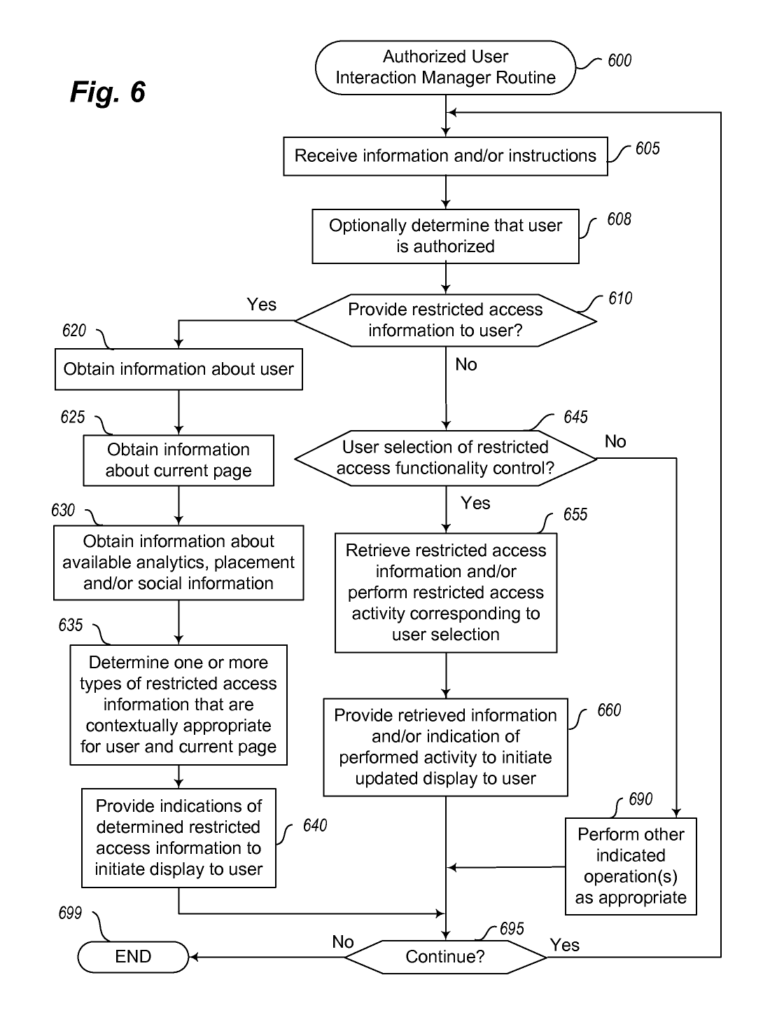

After block 420, or if it was otherwise determined in block 410 that the information received in block 405 was not a request to select one or more content items, the routine continues instead to block 430 to determine if the current interactions involve an indicated user that is authorized to receive restricted access information. As discussed in greater detail elsewhere, such determinations may be made in various manners, including based on login information or other identifying information that is currently or previously provided by the user, based on information that is received or otherwise obtained corresponding to a client device or client software used by the user, etc. The routine then continues to block 440 to determine if the indicated user has been determined to be authorized to receive such restricted access information. If so, the routine continues to block 450 to perform an Authorized User Interaction Manager routine to provide corresponding functionality, with one example of such a routine being discussed in further detail with respect to FIG. 6.

If it was instead determined in block 440 that the indicated user is not determined to be authorized to receive restricted access information, the routine continues instead to block 490 to optionally perform one or more other indicated types of operations as appropriate. Such other types of operations may include, for example, receiving and storing information for later use (e.g., information about users for use in future determinations of whether they are authorized to obtain restricted access functionality, and if so what kinds; information about particular content items, such as for use in future selection of particular content items; information about particular retail items; information about particular target ecommerce sites; etc.); providing functionality to clients related to accounts with the CIS Service or otherwise interacting with advertising clients, such as by executing a client/affiliate interaction manager module of the CIS Service (e.g., the Client/Affiliate Interaction Manager module 346 of FIG. 3); providing executable scripts to target site operators for incorporation in the target sites or otherwise interacting with target site operators, such as by executing a target site interaction manager module of the CIS Service (e.g., the Target Site Interaction Manager module 342 of FIG. 3); performing periodic housekeeping operations; etc.

After blocks 450 or 490, the routine continues to block 495 to determine whether to continue, such as until an explicit indication to terminate is received. If it is determined to continue, the routine returns to block 405, and otherwise continues to block 499 and ends.

FIG. 5 is a flowchart of an example embodiment of a Selection Manager routine 500, such as to provide functionality related to selecting and providing one more appropriate content items for display. The routine 500 may be performed, for example, by the Selection Manager module 344 of FIG. 3, or otherwise by the CIS System 105 of FIG. 1 and/or the CIS Service described with respect to FIGS. 2A-2J. In some situations and embodiments, the routine 500 may be invoked as part of block 420 of FIG. 4, as described in greater detail with respect to FIG. 4.

The routine 500 begins at block 505 in the illustrated embodiment, where one or more instructions and/or types of information are received. The routine then continues to block 510 to determine whether a request has been received to select one or more content items for display or to otherwise present to a particular user, such as in conjunction with other information to be provided to the user regarding one or more particular indicated retail items or other types of target items. If so, the routine continues to block 520 to obtain information about the one or more target items (e.g., a category of target items, a site-wide selection of target items, a single target item, etc.) and the indicated user, such as based at least in part on information received with respect to block 505 and/or by retrieving stored information related to the indicated and/or the target item(s). After block 520, the routine continues to block 525 to retrieve information about one or more recommendation strategies that are available to use to identify appropriate content items and/or about one or more active client campaigns to use to select one or more content items. Such recommendation strategies and/or client campaigns may be identified in various manners.

After block 525, the routine continues to block 530 to determine one or more content items to use that are appropriate for the indicated user and/or target item(s), based at least in part on the retrieved information of block 525. As one example, information may be retrieved at block 525 corresponding to a particular active client campaign, and one or more content items are determined based on that active client campaign. As another example, whether instead of or in addition to the first example, information may be retrieved at block 525 corresponding to one or more recommendation strategies, and those recommendation strategies may be used to determine one or more corresponding content items to use. In other embodiments, the routine may instead receive recommendations from one or more external recommendation services (e.g., optional recommendation service 195 of FIG. 1), and use content items recommended by those one or more external recommendation services, whether instead of or in addition to performing the operations of blocks 520 and 525. In addition, in some embodiments, various additional information may be considered, including a particular location on or within a particular Web page or other information page on which selected content item(s) will be displayed, a particular target site that provides the Web page or other information page on which the selected content item(s) will be displayed, etc. After block 530, the routine continues to block 535 to provide one or more indications of the determined content item(s) to initiate corresponding display to the user.

If it is instead determined in block 510 that the information received in block 505 is not a request to select one or more content items, the routine continues instead to block 590 to perform one or more other indicated operations as appropriate. Such other types of operations may include, for example, receiving and storing information for later use (e.g., information about particular content items, such as for use in future selection of particular content items; information about particular campaigns; information about particular recommendation strategies and optionally corresponding situations in which to use particular strategies; etc.).

After blocks 535 or 590, the routine continues to block 595 to determine whether to continue, such as until an explicit indication to terminate is received. If it is determined to continue, the routine returns to block 505, and otherwise continues to block 599 and ends.

FIG. 6 is a flowchart of an example embodiment of an Authorized User Interaction Manager routine 600, such as to provide restricted access information and associated functionality to authorized users as appropriate. The routine 600 may be performed by, for example, the Authorized User Interaction Manager module 348 of FIG. 3, or otherwise by the CIS Service 105 of FIG. 1 and/or the CIS Service described with respect to FIGS. 2A-2J. The routine 600 may be invoked in various manners in various embodiments, including with respect to block 450 of FIG. 4, and/or based on user interaction with previously provided restricted access information controls, such as in a manner discussed with respect to FIGS. 2A-2J.

The routine 600 begins at block 605 in the illustrated embodiment, where one or more instructions and/or types of information are received. The routine then continues to block 608 to optionally determine whether an indicated user is authorized, although in other embodiments such information may be received in block 605 or otherwise may not be obtained at this time (e.g., based on the operations of block 430 of FIG. 4, based on a request for instructions being received from controls provided to an authorized user in restricted access information 298 of FIGS. 2A-2J, etc.).

After block 608, the routine continues to block 610 to determine whether the information received in block 605 is a request or instruction to provide restricted access information to an authorized user. If so, the routine continues to block 620 to obtain information about the user (e.g., information about previous selections by the user, preferences of the user, a role of the user for a particular entity, authorization of the user for particular types of information, etc.), such as based on information received in block 605, and/or by retrieving stored information about the user. In block 625, the routine then obtains information about a current Web page or other information page via which to provide information to the user, such as based on the information received in block 605—for example, the indicated page may be one of the types of Web pages discussed with respect to FIGS. 2A-2J. After block 625, the routine continues to block 630 to obtain information about available analytics, placement, and/or social information that is available for use to provide to the user, such as based on stored information maintained by the CIS Service.

After block 630, the routine continues to block 635 to determine one or more types of restricted access information that are contextually appropriate for the user and the current page, including based on any instructions received from the user concurrently or previously regarding types of information of interest. For example, when a Web page is first displayed to an authorized user, the CIS Service may in some embodiments determine one or more types of restricted access information that are contextually appropriate for the type of page and/or based on particular elements of information included within the page (e.g., particular content items selected for display on the page, a subject matter of the page, etc.). In addition, after an initial group of restricted access information is displayed to a user, additional requests may be received for additional restricted access information based on user selection of controls in the provided restricted access information or otherwise based on user interactions with information on the page (e.g., a hover selection of a particular piece of information), and the types of restricted access information that are determined in block 635 may be based at least in part on those user selections.

After block 635, the routine continues to block 640 to provide one or more indications of the determined restricted access information to initiate display to the user. As discussed in greater detail elsewhere, such restricted access information may be displayed in various manners to the user, including to modify a currently displayed page or to otherwise provide the restricted access information in a manner associated with such a page. In addition, it will be appreciated that the information provided in block 640 may include user-selectable restricted access controls that the user may subsequently select in order to receive additional later restricted access functionality, and that some or all of the described types of restricted access information and associated functionality may be obtained by particular users in at least some embodiments and situations in manners other than based on using previously provided user-selectable restricted access controls, such as based on use of a separate user interface provided by the CIS Service to authorized users.

If it is instead determined in block 610 that the information received in block 605 is not a request to provide restricted access information to the user, the routine continues instead to block 648 to determine whether the information received in block 605 indicates a user selection to obtain restricted access functionality, such as via an associated control previously provided to the user. If so, the routine continues to block 655 to retrieve additional restricted access information and/or to perform restricted access activity or functionality corresponding to the user selection. If any additional information is retrieved or generated based on the performance of block 655, that additional information is provided in block 660 to initiate a corresponding updated display to the user, and otherwise an indication confirming performance of the indicated activity may be provided.

If it is instead determined in block 645 that the information received in block 605 is not a request for restricted access functionality, the routine continues instead to block 690 to perform one or more other indicated types of operations as appropriate. Such other types of operations may include, for example, receiving and storing information for later use (e.g., information about particular types of information selected by a user; information about preferences of a user; information about a role of a user for a particular entity, information about authorization of a user for particular types of information; information about other users and/or reports associated with an indicated user; etc.).

After blocks 640, 660, or 690, the routine continues to block 695 to determine whether to continue, such as until an explicit indication to terminate is received. If it is determined to continue, the routine returns to block 605, and otherwise continues to block 699 and ends.

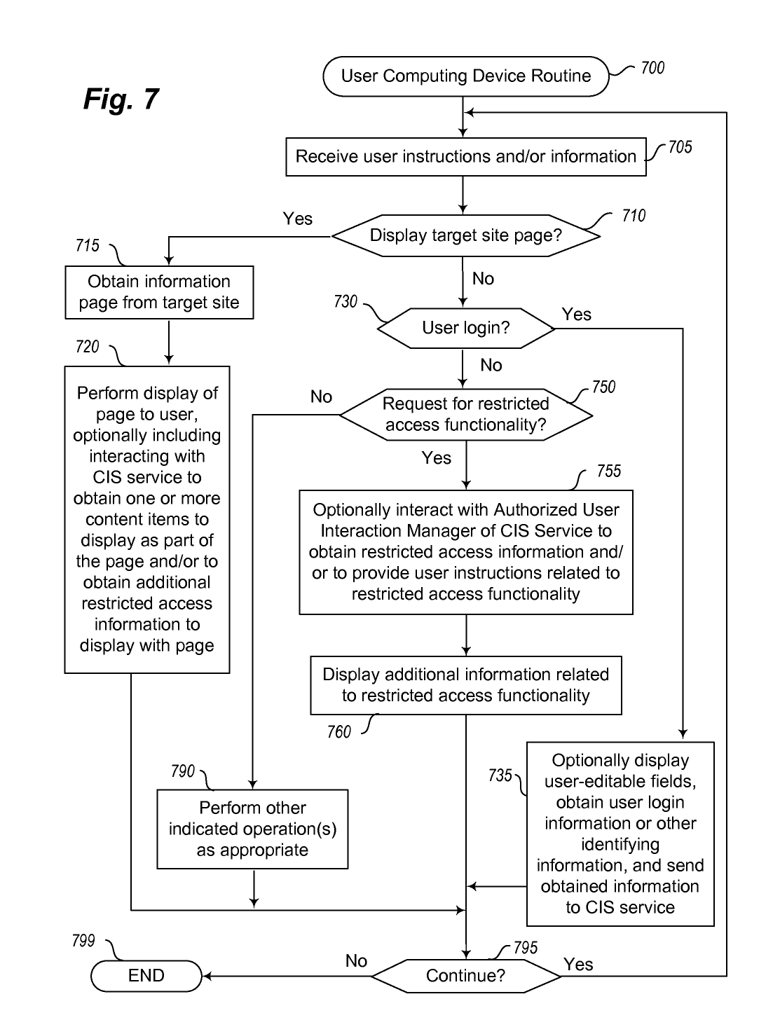

FIG. 7 is a flow chart of an example embodiment of a User Computing Device routine 700, such as to provide a high-level overview of a user who obtains access to functionality of an example embodiment of the CIS Service. The routine 700 may be performed, for example, by a browser 358 or other software executing on a user computing system 350 of FIG. 3 and/or by software executing on a computing device or system of a user 140 or 150 of FIG. 1, such as to interact with an embodiment of a CIS Service to obtain access to at least some of the functionality described with respect to the examples of FIGS. 2B-2J, and more generally to obtain access to functionality provided by some or all of the techniques described herein for providing restricted access information and associated functionality to users.

The routine 700 begins at block 705 in the illustrated embodiment, where one or more user instructions and/or types of information are received. The routine then continues to block 710 to determine whether a user request has been received to display or otherwise present a particular information page from a target site to a user of the computing device, such a Web page or other type of information page. Such other types of information pages may have various forms in various embodiments, such as an email electronic communication formatted using HTML (HyperText Markup Language), or a page of information that is not based on HTML (e.g., a Web page specified using another markup language or data format, an email specified using another format, a Multimedia Messaging Service message or similar communication, a multimedia-based chat or instant message communication, etc.).

If it is determined in block 710 that a user request has been received to display or otherwise present a particular information page, the routine continues to block 715 where the information page is obtained from the target site, whether by interactively requesting and receiving the information page (e.g., by making a request to a Web server of the target site for a Web page), or by retrieving a previously received information page (e.g., by accessing a mail server to obtain a received HTML-based email page). After block 715, the routine continues to block 720 to perform a display of the information page to the user, such as on the computing device or on an associated display device. As discussed in greater detail elsewhere, in some embodiments the display of the information page may automatically initiate one or more requests to an embodiment of the CIS Service to obtain information for display to the user as part of the information page or otherwise in association with the information page (e.g., one or more content items that are selected by the CIS Service, additional restricted access information that is selected by the CIS Service, etc.), and if so such requests are made in block 720 and the display of the resulting selected content item(s) is initiated in block 720. In other embodiments and situations, a particular information page may already have one or more such selected content items (e.g., if the target site obtains the selected content items and provides them together with the information page), or may be displayed without any such selected content items.

If it is instead determined in block 710 that a user request to display or otherwise present a particular information page has not been received, the routine continues to block 730 to determine whether a user request or other interaction has been performed to provide login information or other identifying information to the CIS Service, and if so continues to block 735. Such a user request or other interaction may, for example, involve the user clicking on or otherwise interacting with a user-selectable control in a Web page or other information page that was previously displayed to the user (e.g., in block 720). For example, in at least some embodiments, one or more selected content items provided by the CIS Service may enable the user to access the ability to provide login information (e.g., in a manner that is visible to any user, by accessing hidden or otherwise non-visible functionality that may be known to only authorized users, etc.). In block 735, the routine optionally displays (if not already visible) user-editable fields or other user-selectable controls that allows the user to specify login information or other identifying information, obtains the user-identifying information, and sends the obtained information to the CIS Service to initiate a login process for the user if appropriate. In some embodiments, the providing of such identifying information may further include, if the user is determined to be authorized, modifying a currently displayed information page to enable access of the user to restricted access functionality that corresponds to a level or type of the user's authorization, although in the illustrated embodiment such access is instead enabled with respect to blocks 720 and/or 755-760. The obtaining of the user-identifying information may include, for example, receiving login information (e.g., a username and password) that is typed or otherwise input by the user, or in some embodiments and situations may include automatically retrieving user-specific information (e.g., information that is stored on the user computing device, such as a browser cookie previously stored by the CIS Service and/or a particular target site, sign-on information for one or more particular target sites, sign-on information for a single sign-on service that is separate from but used by the CIS Service, etc.).

If it is instead determined in block 730 that a user request or other interaction to provide login information or other identifying information to the CIS Service has not been received, the routine continues to block 750 to determine whether a user request or other interaction has been performed to initiate access to restricted access information and associated functionality from the CIS Service, and if so continues to block 755. Such a user request or other interaction may, for example, involve the user clicking on or otherwise interacting with a user-selectable control in a Web page or other information page that was previously displayed to the user (e.g., in block 720). In block 755, if the requested restricted access information is not already available, the routine optionally interacts with the CIS Service to obtain restricted access information (optionally that includes restricted access user-selectable controls) to display or otherwise provide to the user. If the request or other interaction in block 705 involved the user providing information and/or instructions by interacting with a restricted access user-selectable control that was already available to the user, the routine in block 755 may further submit to the CIS Service the information and/or instructions provided by the user. After block 755, the routine continues to block 760 to display additional information to the user related to the restricted access functionality, such as additional restricted access information and/or restricted access user-selectable controls that are received from the CIS Service as part of or in response to interactions of block 755, or instead additional restricted access information and/or restricted access user-selectable controls that were previously available to the user computing device but not displayed or otherwise made available to the user. When displaying additional information and/or user-selectable controls in blocks 735 and/or 760, the routine may in some embodiments and situations display a new Web page or other information page, while in other embodiments, one or more of various types of client-side functionality may be used to modify the previously displayed Web page or other information page to newly enable access to such restricted access functionality.

If it is instead determined in block 750 that the instructions/information received in block 705 are not a request or other interaction to obtain access to restricted access functionality, the routine continues to block 790 to optionally perform one or more other indicated operations as appropriate. Such other operations may include, for example, receiving and storing information for later use (e.g., information about restricted access functionality that has not yet been provided to the user; information about particular content items for later display to the user; etc.); performing interactions with the CIS Service to enable a user representative of a client to access information or functionality (e.g., an account of the client) available from the CIS Service for the client, such as to interact with a client/affiliate interaction manager module of the content item selection system (e.g., the Client/Affiliate Interaction Manager module 346 of FIG. 3); performing interactions with the CIS Service to enable a user representative of a target site to access information or functionality available from the CIS Service for the target site, such as to interact with a target site interaction manager module of the content item selection system (e.g., the Target Site Interaction Manager module 342 of FIG. 3); performing periodic housekeeping operations, etc.

After blocks 720, 735, 760 or 790, the routine continues to block 795 and determines whether to continue, such as until an explicit termination indication is received. If it is determined to continue, the routine returns to block 705, and otherwise continues to block 799 and ends.

As discussed in greater detail elsewhere, the ability of a user to access restricted access functionality from the CIS Service may be in addition to (e.g., as an alternative to) another user interface provided by the CIS Service to the user. For example, when obtaining restricted access functionality based on interactions of a user with a Web page or other information page of a target site, the restricted access functionality that is provided may be based at least in part on the context of the user at that target site (e.g., on particular information that the user selects or otherwise indicates on that Web page or other information page, or that is otherwise displayed on that information page). Alternatively, in at least some embodiments and situations, a separate user interface provided by the CIS Service to authorized users may include some or all of the same functionality available to authorized users via routine 700 (and optionally may include additional functionality that is not available via routine 700), but in a manner that is not specific to the context of a particular Web page or other information page or to the context of a particular target site.

Those skilled in the art will also appreciate that in some embodiments the various described systems and modules may each perform functionality that may be expressed in one or more routines, such as to perform various steps or operations in various manners (e.g., in serial or in parallel, in a synchronous or asynchronous manner, in a particular order, etc.), including as is discussed above. It will also be appreciated that in some embodiments the functionality provided by the routine discussed above may be provided in alternative ways, such as being split among more routines. Similarly, in some embodiments the illustrated routine may provide more or less functionality than is described. Those skilled in the art will also appreciate that the data structures discussed above may be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by corresponding claims and the elements recited therein. In addition, while certain aspects have been discussed in specific terms such as to be described as processes and/or systems and/or may be presented at times in certain claim forms, the inventors contemplate the various aspects of the invention in any available claim form, including methods, systems, computer-readable mediums on which are stored executable instructions or other contents to cause a method to be performed and/or on which are stored one or more data structures to enable performance of such a method, etc.

What is claimed is:

1. A computer-implemented method, comprising:
receiving instructions from an online retailer to supply advertisements as part of a Web site provided by the online retailer for a plurality of customers, the receiving of the instructions being performed by one or more configured computing systems of a selection service distinct from the online retailer;
receiving, by the one or more configured computing systems, information about a group of multiple users that perform business operations for the online retailer and are authorized to obtain confidential information about the business operations, the multiple users being distinct from the plurality of customers, the confidential information not being accessible to the plurality of customers;
receiving, by the one or more configured computing systems, a request related to providing to a first user a first Web page of the Web site that is associated with one or more products available for purchase from the online retailer;
selecting, by the one or more configured computing systems, one or more advertisement content pieces to be displayed to the first user as part of the first Web page, the selected advertisement content pieces providing recommendations of one or more additional products distinct from the one or more products;
determining, by the one or more configured computing systems, that the first user is authorized to obtain access to the confidential information about the business operations based on being one of the group of multiple users;
in response to the determining, selecting, by the one or more configured computing systems, one or more elements of information to include in additional restricted information displayed to the first user as part of the first Web page, the selected one or more elements including at least some of the confidential information about the business operations and indicating recent actions of one or more other users of the multiple users who the first user has previously selected and indicating information about prior sales of the one or more products by the online retailer and indicating information about prior results of using the selected advertisement content pieces for the online retailer on the Web site; and
providing, by the one or more configured computing systems, information that includes the selected advertisement content pieces and the additional restricted information to a client computing device of the first user to initiate display of the provided information to the first user as part of the first Web page.

2. The method of claim 1 wherein the additional restricted information includes one or more user-selectable controls to enable the first user to control the at least some confidential information that is included in the additional restricted information provided to the first user, and wherein the method further comprises providing updated restricted information to the computing device of the first user in response to selection by the first user of the one or more user-selectable controls, the updated restricted information differing from the additional restricted information in one or more manners corresponding to the selection by the first user.

3. The method of claim 2 wherein the additional restricted information further includes one or more additional user-selectable controls to enable the first user to designate an additional other user of the multiple users, such that the updated restricted information provided to the first user further indicates recent actions of the additional other user based on the first user using the one or more additional user-selectable controls to designate the additional other user.

4. The method of claim 1 wherein the selected one or more elements of information that indicate recent actions of the one or more other users include information about activities of the one or more other users that are part of performing business operations for the online retailer, wherein the selected one or more elements of information that indicate information about prior sales of the one or more products by the online retailer include information about merchandising analytics for the online retailer regarding the one or more products, and wherein the method further comprises, under control of the client computing device of the first user:
receiving the first Web page from a configured computer system of the online retailer, and receiving the provided information from the one or more configured computing systems of the selection service; and
displaying the first Web page on the client computing device, the displayed Web page including a display of the one or more advertisement content pieces and a display of the provided additional restricted information.

5. A computer-implemented method, comprising:
receiving, by one or more configured computing systems, information about a group of multiple users that are authorized to obtain restricted information about business operations of an online retailer, the restricted information not being accessible to customers of the online retailer distinct from the multiple users;
receiving, by the one or more configured computing systems, an indication related to providing a Web page of a retail Web site of the online retailer to an indicated user of the multiple users;
determining, by the one or more configured computing systems, to include additional information for the indicated user that is associated with the Web page based at least in part on the indicated user being included in the group of multiple users;
selecting, by the one or more configured computing systems, one or more elements of information to include in the additional information for the indicated user based at least in part on information specific to the indicated user and on information specific to the Web page, the selected one or more elements including at least some of the restricted information and indicating actions by one or more other users of the multiple users who are associated with the indicated user, the actions being related to the business operations of the online retailer; and
providing, by the one or more configured computing systems, the additional information to the indicated user for display with the Web page.

6. The method of claim 5 further comprising:
receiving, by the one or more configured computing systems, an indication related to providing the Web page to a second user; and
determining, by the one or more configured computing systems, to not include any additional restricted information for the second user based at least in part on the second user not being included in the group of multiple users.

7. The method of claim 5 wherein the at least some of the restricted information includes information about activities of the one or more other users that are part of performing the business operations for the online retailer.

8. The method of claim 7 wherein the Web page relates to one or more retail items available from the online retailer, and wherein the activities of the one or more other users include prior activities related to the one or more retail items or to a group of multiple retail items that include the one or more retail items.

9. The method of claim 7 wherein the Web page relates to one or more retail items available from the online retailer, and wherein the activities of the one or more other users include current activities related to the one or more retail items or to a group of multiple retail items that include the one or more retail items, such that the providing of the additional information occurs in real-time for the current activities.

10. The method of claim 7 wherein the activities of the one or more other users include boosting recommendations for one or more indicated retail items, and wherein the selected one or more elements of information include an indication that the recommendations for one or more indicated retail items are boosted by an indicated user.

11. The method of claim 7 wherein the activities of the one or more other users include providing a comment about one or more indicated user actions or about one or more merchandising activities for the online retailer, and wherein the selected one or more elements of information include the comment and an indication of a user that provided the comment.

12. The method of claim 7 wherein the activities of the one or more other users include indicating that a user likes an indicated user action, an indicated merchandising activity, an indicated user, or an indicated retail item, and wherein the selected one or more elements of information include an indication that at least one user likes the indicated user action, the indicated merchandising activity, the indicated user, or the indicated retail item.

13. The method of claim 7 wherein the activities of the one or more other users include indicating to share a piece of information with at least one other user, and wherein the selected one or more elements of information include the shared piece of information.

14. The method of claim 7 wherein the activities of the one or more other users include indicating to ask a question, and wherein the selected one or more elements of information include the question.

15. The method of claim 7 wherein the indicated user previously indicated to follow at least one other user, and wherein the selected one or more elements of information include information about the at least one user.

16. The method of claim 7 wherein the at least some of the restricted information further includes information about a current status of the one or more other users.

17. The method of claim 5 wherein the one or more configured computing systems are part of a selection service distinct from the online retailer, and wherein the additional information provided to the indicated user further includes statistical information from the selection service about performance of the business operations of the online retailer.

18. The method of claim 5 further comprising receiving a selection by the indicated user of at least one of the multiple other users, and specifying the at least one user to be among the one or more other users associated with the indicated user.

19. The method of claim 5 further comprising automatically determining that at least one of the multiple other users is relevant to the indicated user, and specifying the at least one user to be among the one or more other users associated with the indicated user.

20. The method of claim 5 wherein the one or more configured computing systems are part of a selection service distinct from the online retailer, and wherein the method further comprises providing social networking functionality for the group of multiple users, and obtaining information about at least some of the actions by the one or more other users from the provided social networking functionality.

21. The method of claim 5 further comprising obtaining, from a social networking service distinct from the online retailer, information about at least some of the actions by the one or more other users.

22. The method of claim 5 wherein the Web page relates to one or more retail items available from the online retailer, and wherein the selected one or more elements further include confidential information for the online retailer about at least one of prior sales of the one or more retail items by the online retailer, and of information about current merchandising activities for the online retailer regarding the one or more retail items.

23. The method of claim 22 wherein the confidential information for the online retailer includes information about one or more of an overall sales rank of the one or more retail items for the retail Web site, a sales rank of the one or more retail items for a category to which the one or more retail items belong, a sales rank of the one or more retail items for a brand to which the one or more retail items belong, a history of sales of the one or more retail items, a click-through rate for recommendations of the one or more retail items, occurrences of prior recommendations of the one or more retail items, a history of pricing of the one or more retail items, one or more search keywords that led to purchases of the one or more retail items, and an amount of time that customers have spent viewing information about the one or more retail items.

24. The method of claim 5 wherein the Web page includes one or more selected placement content pieces, and wherein the selected one or more elements further include confidential information for the online retailer about at least one of prior results of using the selected placement content pieces for the online retailer on the retail Web site, and of information about current activities for the online retailer involving use of the one or more selected placement content pieces.

25. The method of claim 24 wherein the confidential information for the online retailer includes information about one or more of a click-through rate for the one or more selected placement content pieces, a conversion rate for the one or more selected placement content pieces, a cost related to use of the one or more selected placement content pieces, and a promotional campaign associated with the one or more selected placement content pieces.

26. The method of claim 24 wherein the one or more selected placement content pieces include one or more retail item recommendation content pieces, one or more advertisement content pieces, and one or more promotion content pieces, and wherein the confidential information includes information related to each of the one or more retail item recommendation content pieces, one or more advertisement content pieces, and one or more promotion content pieces.

27. The method of claim 24 wherein the Web page relates to one or more retail items available from the online retailer, wherein the one or more configured computing systems are part of a selection service distinct from the online retailer, wherein the method further comprises selecting the one or more placement content pieces to include as part of the Web page based at least in part on information about one or more of the indicated user and the one or more retail items, and wherein the providing of the additional information further includes providing one or more indications of the selected placement content pieces for display to the indicated user as part of the Web page.

28. The method of claim 5 wherein the multiple users of the group are designated representatives of the online retailer, and wherein the restricted information corresponds to merchandising information for the online retailer.

29. The method of claim 5 wherein the multiple users of the group are designated representatives of an advertiser distinct from the online retailer, and wherein the restricted information corresponds to information about advertising performed for the advertiser involving at least the online retailer.

30. The method of claim 5 wherein the Web page relates to one or more retail items available from the online retailer, wherein the multiple users of the group are designated representatives of a supplier of the one or more retail items, and wherein the restricted information corresponds to information about merchandising involving at least the online retailer for items supplied by the supplier.

31. The method of claim 5 wherein the one or more configured computing systems are part of a selection service distinct from the online retailer, wherein the multiple users of the group are designated representatives of the selection service, and wherein the restricted information corresponds to information obtained by the selection service related to the business operations of the online retailer.

32. The method of claim 5 wherein the Web page includes multiple selected placement content pieces, wherein the method further comprises receiving an indication of a hover-based selection of one of the multiple placement content pieces, and wherein the selected one or more elements further include confidential information for the online retailer about use of the one placement content piece based on the hover-based selection.

33. The method of claim 5 wherein the one or more configured computing systems are part of a selection service distinct from the online retailer, and wherein the method further comprises obtaining the restricted information about the business operations of the online retailer from one or more of tracked online activities of customers of the retail Web site, information based on customer use of an affinity program for the online retailer, information from a customer relationship management system of the online retailer, and information from an employee tracking system of the online retailer.

34. The method of claim 5 wherein the online retailer has one or more physical store locations, and wherein the additional information for the indicated user includes information corresponding to merchandising activities for at least one of the physical store locations.

35. The method of claim 5 wherein the selecting of the one or more elements of information to include in the additional information for the indicated user based at least in part on information specific to the indicated user and on information specific to the Web page includes automatically determining information that is contextually appropriate to a context of the Web page.

36. The method of claim 35 wherein the one or more configured computing systems are part of a selection service distinct from the online retailer, and wherein the method further comprises providing to the indicated user, by the one or more configured computing systems, a distinct user interface of the selection service that is separate from any Web pages of the online retailer, the provided user interface supplying access to confidential information of the online retailer that is not specific to the context of the Web page.

37. The method of claim 5 wherein the providing of the additional information to the indicated user further includes providing access to one or more user-selectable controls to enable the indicated user to control portions of the restricted information that are provided to the indicated user, and wherein the method further comprises providing updated restricted information to the indicated user in response to a selection by the indicated user of at least one of the user-selectable controls.

38. The method of claim 5 wherein the one or more configured computing systems are part of a selection service distinct from the online retailer, wherein the provided Web page does not include any placement content pieces selected by the selection service for inclusion on the provided Web page, and wherein the providing of the additional information to the indicated user further includes providing information related to placement content pieces that would be selected by the selection service for inclusion on the provided Web page if the selection service was requested to include placement content pieces on the provided Web page.

39. The method of claim 5 wherein the one or more configured computing systems are part of a selection service distinct from the online retailer, wherein the provided Web page does not include any placement content pieces selected by the selection service for inclusion on the provided Web page, and wherein the providing of the additional information to the indicated user further includes providing one or more user-selectable controls to enable the indicated user to initiate future inclusion on the provided Web page of placement content pieces that are selected by the selection service.

40. The method of claim 5 wherein the Web page relates to one or more retail items available from the online retailer, and wherein the one or more retail items correspond to at least one of a category of multiple retail items or a brand having multiple associated retail items.

41. The method of claim 5 wherein the online retailer is one of multiple online commerce sites that are clients of a distinct selection service and that receive functionality related to display of restricted information to authorized users as part of Web pages provided by the multiple online commerce sites, and wherein the one or more configured computing systems are part of a selection service operated by an entity that is distinct from multiple operators of the multiple online commerce sites.

42. A non-transitory computer-readable medium having stored contents that configure a computing system to perform a method, the method comprising:
receiving, by the configured computing system, information about a group of multiple users that are authorized to obtain restricted information related to operation of a commerce Web site, the restricted information not being accessible to additional users of the commerce Web site that are distinct from the multiple users;
receiving, by the configured computing system, an indication related to providing a Web page of the commerce Web site to an indicated user of the multiple users;
selecting, by the configured computing system, one or more elements of information to include for the indicated user in additional information associated with the Web page based at least in part on the indicated user being included in the group of multiple users, the selected one or more elements including at least some of the restricted information and indicating actions of one or more other users of the multiple users that are associated with the indicated user; and
providing, by the configured computing system, the additional information for display to the indicated user with the Web page.

43. The non-transitory computer-readable medium of claim 42 wherein the commerce Web site is operated by an online retailer to provide retail items to customers of the commerce Web site, wherein the restricted information related to operation of the commerce Web site includes information about merchandising activities of the online retailer regarding the providing of the retail items to the customers, and wherein the selecting of the one or more elements of information to include for the indicated user in the additional information includes automatically determining information that is contextually appropriate to a context of the Web page based at least in part on information specific to the indicated user and on information specific to the Web page.

44. The non-transitory computer-readable medium of claim 42 wherein the Web page is related to or more commerce items and includes at least one placement content item, and wherein the selecting of the one or more elements of information to include for the indicated user in the additional information includes selecting information about activities of other users designated by the indicated user and further includes selecting information about merchandising activities at the commerce Web site regarding the one or more commerce items and about use of the at least one placement content item at the commerce Web site.

45. The non-transitory computer-readable medium of claim 42 wherein the commerce Web site provides functionality of one or more of an online travel commerce site, an online automotive commerce site, an online commerce site of a financial organization, and an online commerce site that provides access to digital content.

46. The non-transitory computer-readable medium of claim 42 wherein the configured computing system is part of a selection system that is distinct from an online retailer that provides the commerce Web site, wherein the computer-readable medium is a memory of the configured computing system, and wherein the contents are instructions that when executed program the configured computing system to perform the method.

47. A system, comprising:
one or more processors of one or more computing systems; and
a selection system that is configured to, when executed by at least one of the one or more processors, automatically determine restricted information to provide to authorized users of an online retailer site by, for each of one or more of the authorized users:
receiving a request to provide additional information for inclusion as part of an electronic information page from the online retailer site to be presented to the authorized user, the electronic information page including information about one or more retail items;
selecting, based at least in part on the authorized user being determined to be authorized, one or more elements of information to include for the authorized user in the additional information from the restricted information, the restricted information being related to operation of the online retailer site and not being accessible to customers of the online retailer site distinct from the authorized users, the selected one or more elements of information being based at least in part on information specific to the electronic information page and on information specific to the authorized user, the selected one or more elements of information indicating actions of one or more other users that are associated with the authorized user; and
providing the additional information for display to the authorized user with the electronic information page.

48. The system of claim 47 wherein the online retailer site is a commerce Web site operated by an online retailer to provide retail items to customers, wherein the restricted information relates to business operations of the commerce Web site and includes information about merchandising activities of the online retailer regarding the providing of the retail items to the customers, and wherein, for one of the authorized users, the electronic information page is a Web page of the commerce Web site, and the selecting of the one or more elements of information to include for the authorized user in the additional information includes automatically determining information that is contextually appropriate to a context of the Web page.

49. The system of claim 48 wherein the Web page includes at least one placement content item, and wherein the selecting of the one or more elements of information to include for the one authorized user in the additional information includes selecting information about activities of other users designated by the one authorized user and further includes selecting information about merchandising activities at the commerce Web site regarding the one or more retail items and about use of the at least one placement content item at the commerce Web site.

50. The system of claim 47 wherein, for each of one or more of the authorized users, the providing of the additional information includes sending one or more electronic communications that include information about the additional information, the sent one or more electronic communications enabling inclusion of the additional information as part of the electronic information page when presented to the authorized user.

51. The system of claim 47 wherein, for each of one or more of the authorized users, the electronic information page for the authorized user is an email communication sent to the authorized user that is formatted at least in part using HyperText Markup Language (HTML).

52. The system of claim 47 wherein the selection system is operated by an operator of the online retailer site.

53. The system of claim 47 wherein the selection system is a contextual information selection system that includes software instructions for execution by the at least one processors to configure those at least one processors to perform the automatic determining of the restricted information to provide to the authorized users of the online retailer site.

54. The system of claim 47 wherein the selection system consists of one or more means for performing the automatic determining of the restricted information to provide to the authorized users of the online retailer site.
